(19) United States
(12) Patent Application Publication
(10) Pub. No.: US 2026/0054843 A1
(43) Pub. Date: Feb. 26, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US); Trevor H. Wood, Clifton Park, NY (US); Kishore Ramakrishnan, Rexford, NY (US)

(21) Appl. No.: 19/371,634

(22) Filed: Oct. 28, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/18; B64D 27/40; F01D 5/14; F01D 5/28; F01D 9/04; F02K 3/02

(52) U.S. Cl. CPC B64D 27/18; B64D 27/402; F01D 5/141; F01D 5/282; F01D 9/041; F02K 3/02; F05D 2220/323; F05D 2240/121; F05D 2240/122; F05D 2240/125; F05D 2300/603

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATIONS

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle (D for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers;

FIG. 11 comprises a schematic representation showing exemplary locations of a point P of one of the unducted fan propulsors, as defined herein, within the first ellipse, the second ellipse, the third ellipse, and the fourth ellipse;

FIG. 12A is a perspective view of the outlet guide vane of FIGS. 3-5A;

FIG. 12B is a cross-sectional view of the outlet guide vane of FIGS. 3-5A;

FIG. 13A is an example side view of the outlet guide vane of FIGS. 3-5A;

FIG. 13B is another example side view of the outlet guide vane of FIGS. 3-5A;

FIG. 13C is an elevational cross-sectional view of an exemplary unducted fan propulsor having a plurality of blades arranged in a forward array and a rearward array;

FIG. 14 is a plot representative of a relationship between a chord length of the outlet guide vane of FIGS. 3-5A and 12A-13B as a function of a distance from an axis of rotation of the unducted fan propulsor of FIGS. 1-5B in a radial direction;

FIG. 15 is another plot representative of a relationship between a chord length of the outlet guide vane of FIGS. 3-5A and 12A-13B as a function of a span of the outlet guide vane in a radial direction defined by the unducted fan propulsor of FIGS. 1-5B;

FIG. 16 is an isolated side view of the outlet guide vane of FIGS. 3-5A and/or 12A-13B;

FIG. 17 is another isolated side view of the outlet guide vane of FIGS. 3-5A and/or 12A-13B;

FIG. 18 is an isolated view of another example outlet guide vane having a wavy leading edge that can be implemented in the outlet guide vane of FIGS. 3-5A and/or 12A-13B;

FIG. 19 is an isolated view of another example outlet guide vane having another wavy leading edge that can be implemented in the outlet guide vane of FIGS. 3-5A and/or 12A-13B;

FIG. 20A is an example implementation of the outlet guide vane of FIGS. 3-5A and/or 12A-13B including a metal leading edge;

FIG. 20B is an example implementation of the outlet guide vane of FIGS. 3-5A and/or 12A-13B including a metal tip cap; and

FIG. 20C is an example implementation of the outlet guide vane of FIGS. 3-5A and/or 12A-13B including the metal leading edge of FIG. 20A and the metal tip cap of FIG. 20B.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section.

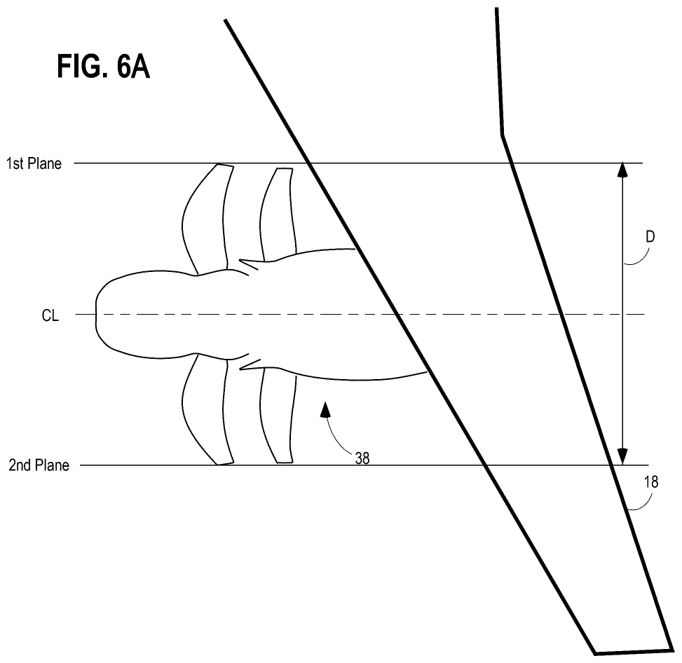

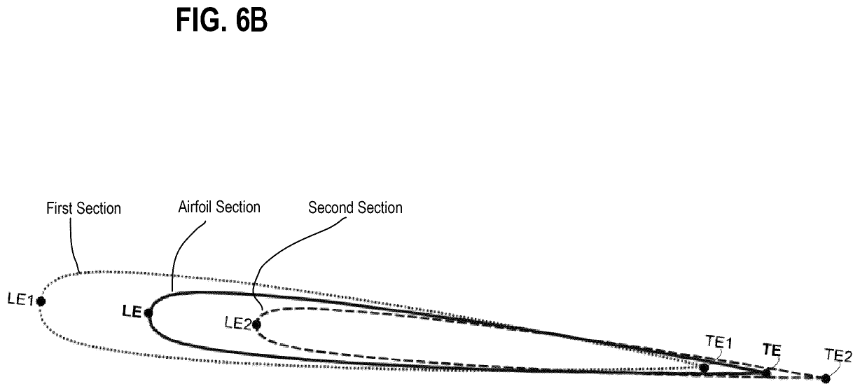

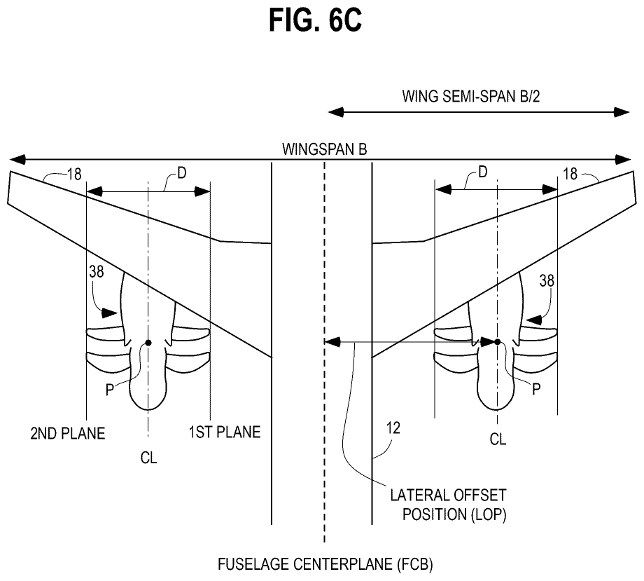

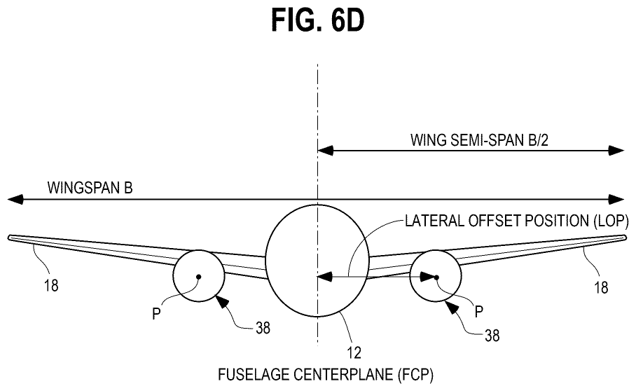

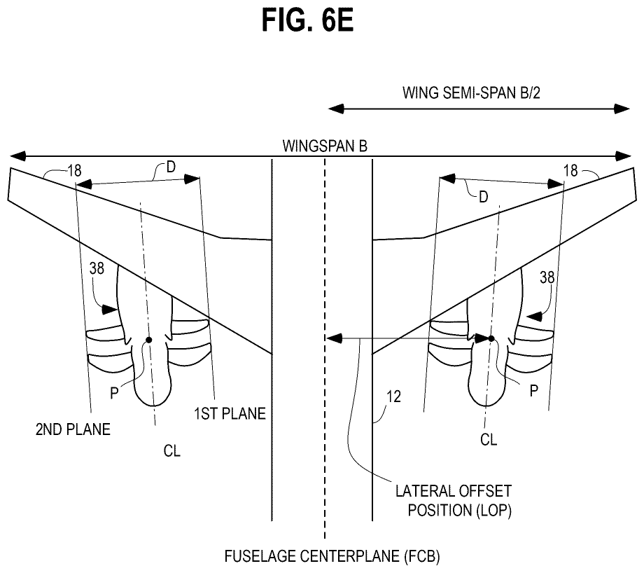

Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

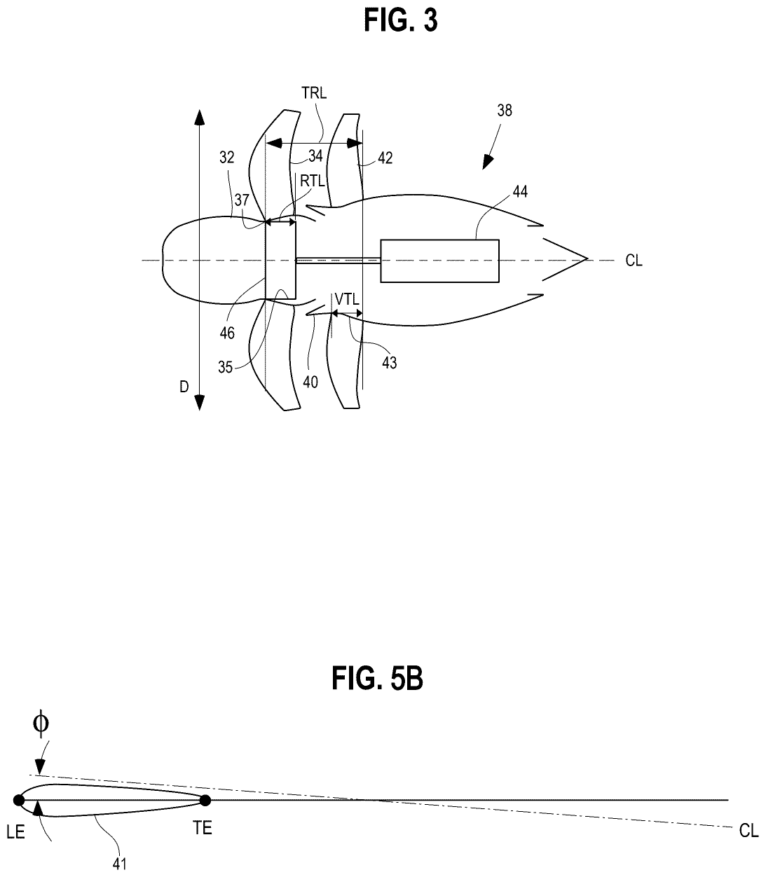

“Unducted fan propulsor” (also referred to as an unducted propulsion system) as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

As used herein, “sweep” is defined as an axial displacement of an airfoil's leading edge (e.g., a vane leading edge) from a baseline radial position.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor, it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output/outlet guide vanes (OGV) or input/inlet guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

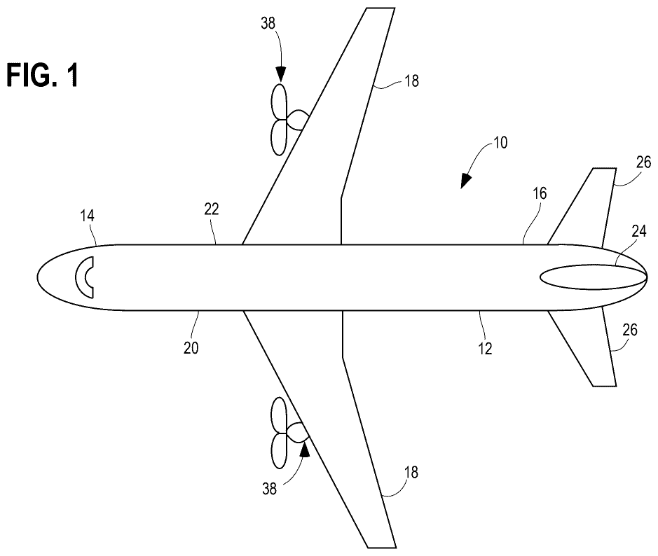

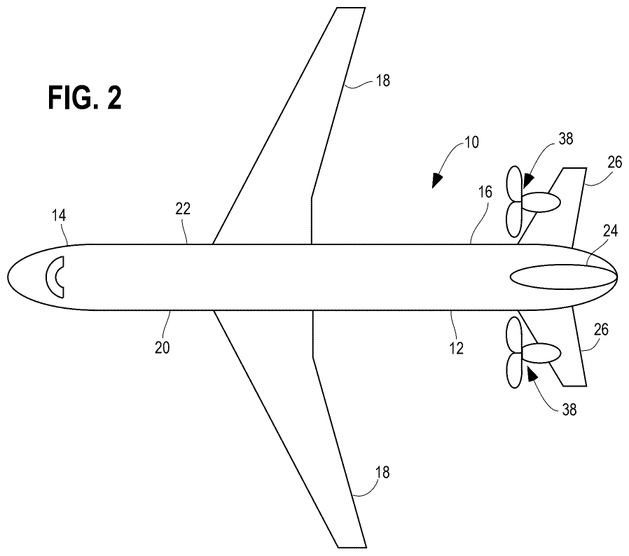

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 (such as OGVs, etc.) disposed around CL.

Outlet guide vanes (OGVs) do not rotate about an axis and are placed aerodynamically downstream of the rotating blade assembly 32. The OGVs impart a change in tangential velocity that is opposite to the direction of tangential velocity imparted by the rotor, referred to as de-swirl. By de-swirling the air that it receives from the rotating blade assembly 32, the vane assembly 40 reduces the magnitude of the tangential velocity of the air that passes through it, effectively converting the tangential momentum into axial momentum or thrust.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

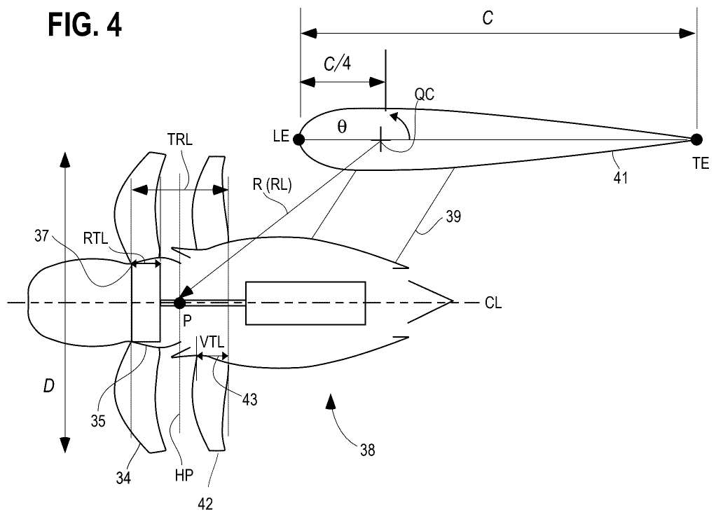

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

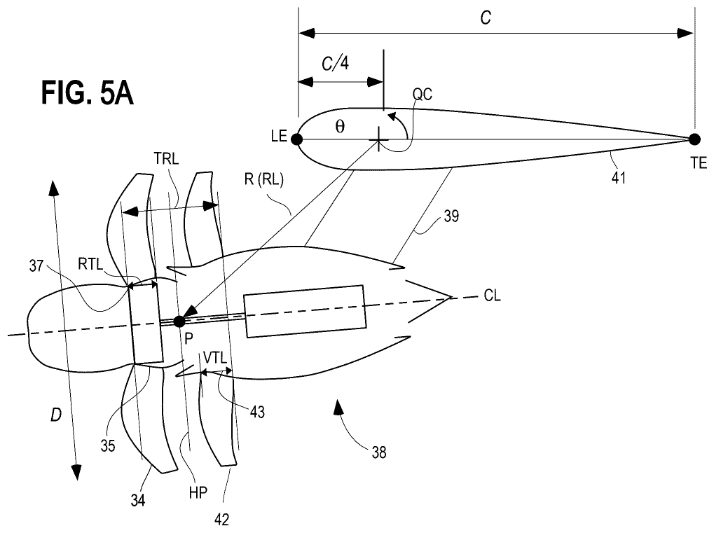

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle (for the propulsor 38, which is the angle spanned between the propulsor centerline CL and chord line C. Positive pitch corresponds to a clockwise rotation of CL relative to C. The pitch angle (can be fixed or variable during flight. For underwing installations, the pitch angle (can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle (can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

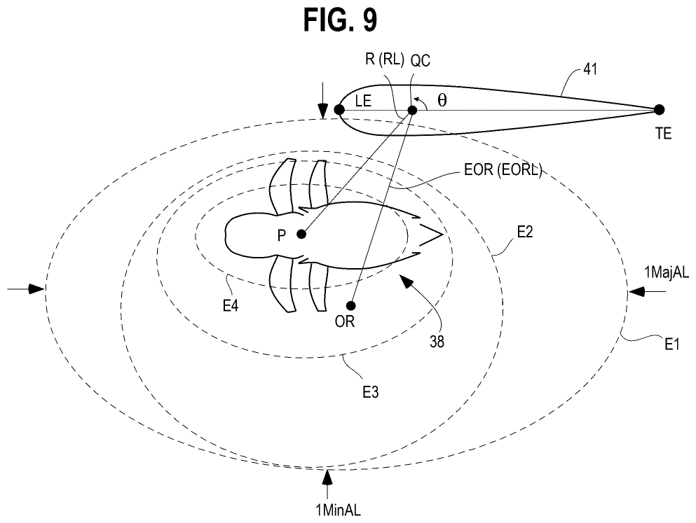

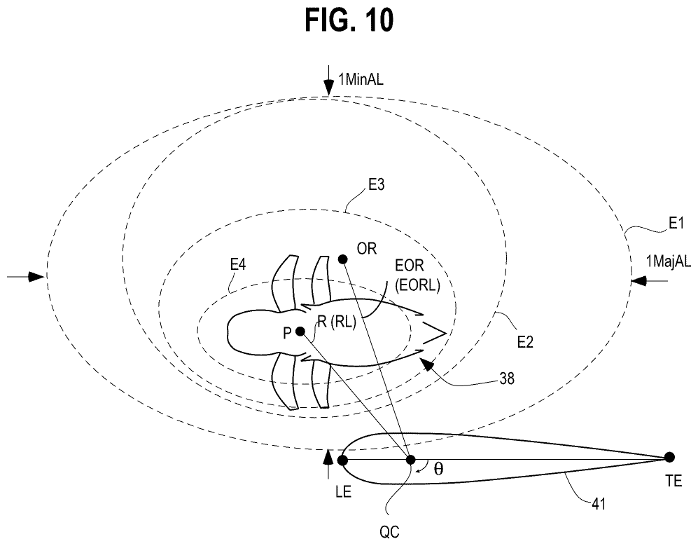

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

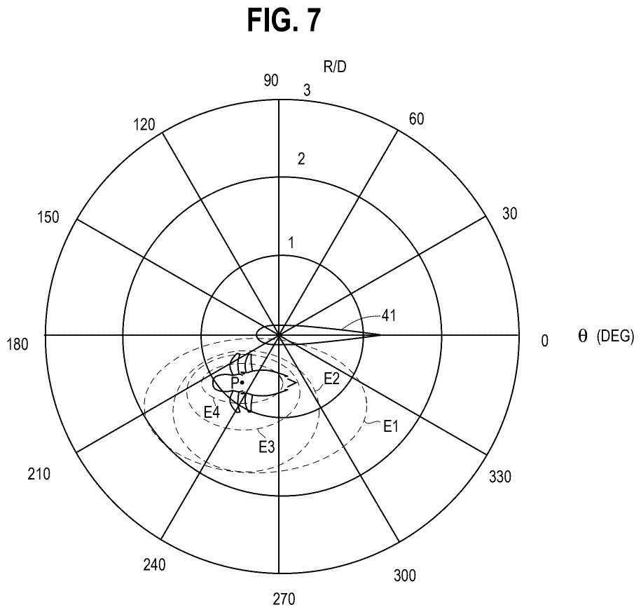

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. An unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. An unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. An unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. An unducted fan propulsor located within E4 tends to offset scrubbing and interference drag.

The location of the unducted fan propulsor system (i.e., point P) relative to the airfoil section may also be expressed in terms of the following expressions:

$$\frac{R L}{D} + \frac{\begin{matrix}( \sqrt{a * [ b * {sin}^{2} ( θ ) - c * {cos}^{2} ( θ ) + d * sin ( θ ) * cos ( θ ) ]} + \\ e * sin ( θ ) + f * cos ( θ ) )\end{matrix}}{g * {sin}^{2} ( θ ) + h * {cos}^{2} ( θ )} > 0 ; \qquad ( Eq . 1 )$$

$$and$$

$$\frac{R L}{D} + \frac{\begin{matrix}( - \sqrt{a * [ b * {sin}^{2} ( θ ) - c * {cos}^{2} ( θ ) + d * sin ( θ ) * cos ( θ ) ]} + \\ e * sin ( θ ) + f * cos ( θ ) )\end{matrix}}{g * {sin}^{2} ( θ ) + h * {cos}^{2} ( θ )} < 0 , \qquad ( Eq . 2 )$$

where 0.07<RL/D<1.98 and θ is between 187° and 340°, and where a, b, c, d, e, f g and h have the values set forth in the following table under the heading “Fifth Emb.”

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

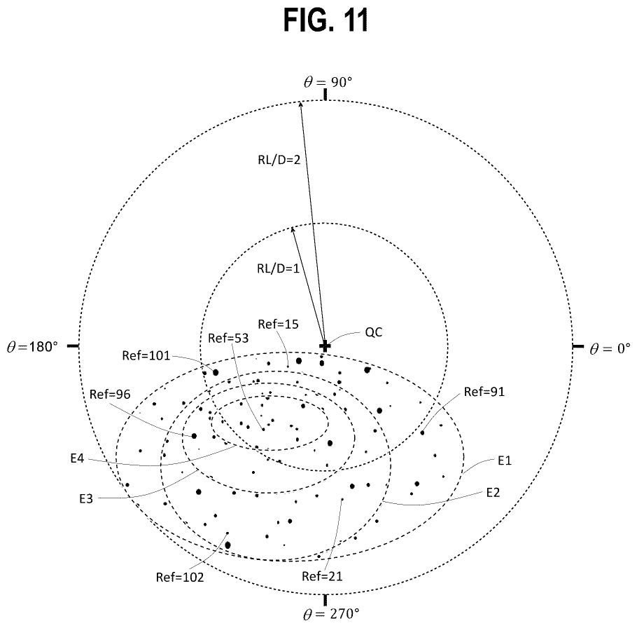

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to airfoil section quarter chord point (QC)

| | Type of | | | | |
|---|---|---|---|---|---|
| Ref. | aircraft | RL (ft) | D (ft) | θ (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator for | |
|---|---|
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinA | | | |
|---|---|---|---|---|---|---|---|
| D (ft) | θ (deg) | (ft) | (ft) | L (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

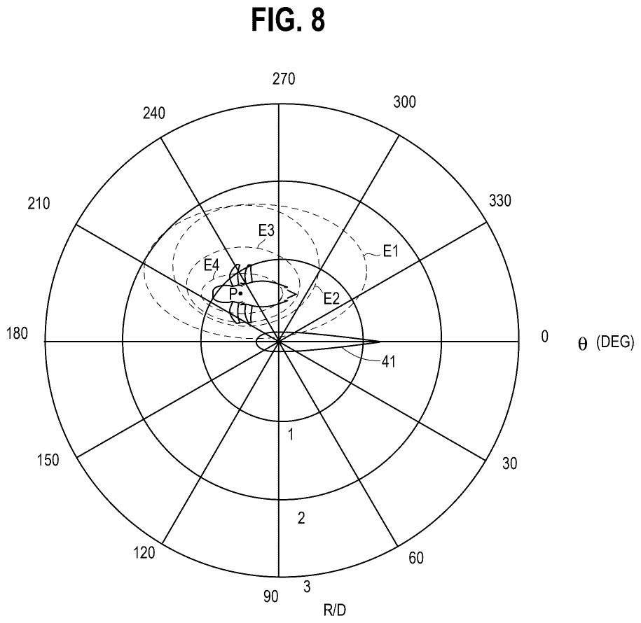

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{net}}{{ρ}_{0} {A}_{a n} {V}_{0}^{2}} . \qquad ( Eq . 3 )$$

In the above thrust parameter, Fₙₑₜ is cruise fan net thrust, ρ₀ is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{a n} {V}_{0}^{2}} > 0 \text{.06} . \qquad ( Eq . 4 )$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to offset drag penalties resulting from the installation of unducted fan propulsors.

As noted above, the array of vanes 42 in the vane assembly 40 can be an array of outlet guide vanes (OGVs). However, positioning OGVs 42 in proximity to a leading edge of the wing 18 (e.g., in a wing-mounted installation) increases aero-acoustic distortion felt by the OGVs. Generally, incorporating OGV sweep from hub to tip reduces interaction noise due to fan wakes impinging on the OGV but moves the tip of the OGV closer to the wing, which creates closer interference or aero-acoustic distortion between the OGV and the wing. The increased aero-acoustic distortion increases noise caused by interaction between the OGVs and the open fan (e.g., propeller assembly 32 and blades 34) when installed.

Wing distortion affects the OGVs at takeoff, but the inventors determined unexpectedly that it is sufficient to maximize OGV tip sweep in the most acoustically active portion of the span, reducing installed interaction noise. Specifically, by placing the belly of the OGV forward and outboard, the inventors designed the OGV tip slightly further from the wing leading edge to strike a better balance between sweep for fan-wake interaction noise reduction and wing induced distortion to optimize for both installed performance and noise. That is, the inventors started the OGV sweep from the belly of the OGV, rather than the hub, to create more sweep in the acoustically active portion of the OGV span without excess compromise to the mechanical design. Such OGV belly positioning creates the largest sweep of the OGV, which, given proximity to the wing, reduces a source of noise (e.g., internal cabin noise and/or external environment/community noise, etc.).

The OGVs are shaped to minimize or otherwise reduce noise produced by the unducted propulsion system and maximize or otherwise increase an efficiency of the unducted fan propulsor 38. For example, the OGVs can help the unducted propulsion system have a cruise Mach greater than 0.7. Rotation of the propeller assembly 32 of the fan propulsor 38 causes an acceleration of the air stream that produces thrust. However, an increase in the acceleration of the airstream also tends to increase drag caused by the OGVs and, thus, thrust losses within the array of OGVs 42. The OGVs disclosed herein are configured to minimize or otherwise reduce drag at high Mach flight and maximize or otherwise increase thrust for a given power input.

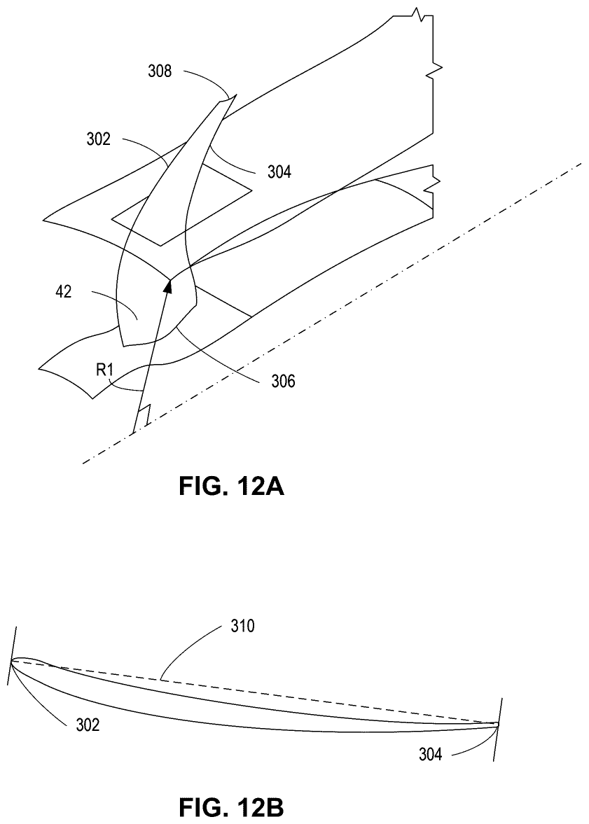

FIG. 12A illustrates an isolated perspective view of one of the OGVs 42 of the fan propulsor 38. The OGV 42 includes a leading edge 302, a trailing edge 304, a hub 306 (e.g., a root, an inner radial surface), and a tip 308 (e.g., an outer radial surface). The leading edge 302 is a portion of the OGV 42 that receives incoming airflow in typical operations performed by the unducted propulsor 38 (e.g., cruise). The trailing edge 304 is a portion of the OGV 42 from which the airflow departs in the typical operations. More particularly, for non-rotating blades, such as the OGV 42, a surface of the blade that produces a higher static pressure, typically due to having a concave shape, can be referred to as the pressure surface. A surface of the blade that produces a lower static pressure, typically due to having a convex shape, can be referred to as a suction surface. The leading edge of a blade (e.g., the leading edge 302) is used herein to refer to a three-dimensional curve at which the suction surface and pressure surface meet on an upstream edge of the blade, based on the flight direction. A trailing edge refers to an intersection of the same suction surface and pressure surface on the downstream edge of the blade.

FIG. 12B illustrates a cross-sectional view of the OGV 42 taken at a radius R1 (e.g., a distance from the axis of rotation (e.g., CL) in the radial direction R) that is constant from the leading edge 302 to the trailing edge 304. Specifically, the cross-sectional view of FIG. 3B shows a chord length 310 of the OGV 42. The chord length 310 and a location of the chord length 310 along the height of the OGV 42 affect the aerodynamic performance and an efficiency of the OGV 42. Examples disclosed herein optimize the chord length 310 and a distribution of the chord length 310 to maximize or otherwise improve the aerodynamic performance and efficiency of the OGV 42 and, in turn, the unducted fan propulsor 38.

As used herein, the “chord” or “chord length” (C) of an airfoil, such as the OGV 42, is a straight line distance between a leading edge (e.g., the leading edge 302) and a trailing edge (e.g., the trailing edge 304) at a given radius R1 along a height of the airfoil (e.g., a line of constant radius between the hub 306 and the tip 308). FIG. 12B is representative of a cross-section of the OGV 42 taken along the radius R1. As such, the “chord” or “chord length” can also be referred to as a width of the airfoil at the radius R1. As used herein, because the OGV 42 does not have both a leading edge (e.g., the leading edge 302) and a trailing edge (e.g., the trailing edge 304) at some radii (e.g., at some distances from the axis of rotation such as CL) occupied by a portion of the OGV 42 (e.g., at a minimum radius of the hub 306 and/or a maximum radius of the tip 308), the “chord” of the hub 306 and the tip 308 is discussed in the context of nearest radius at which both the leading edge 302 and the trailing edge 304 are positioned.

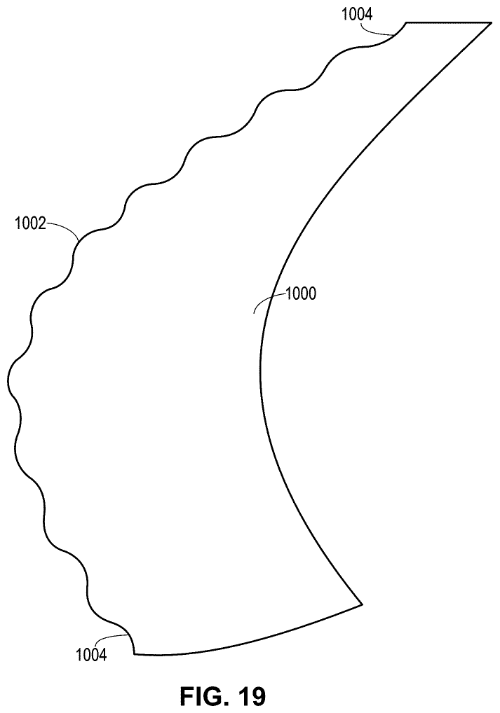

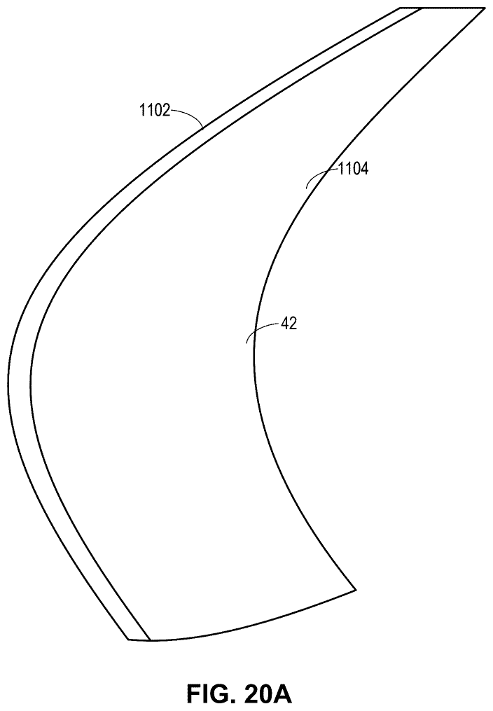

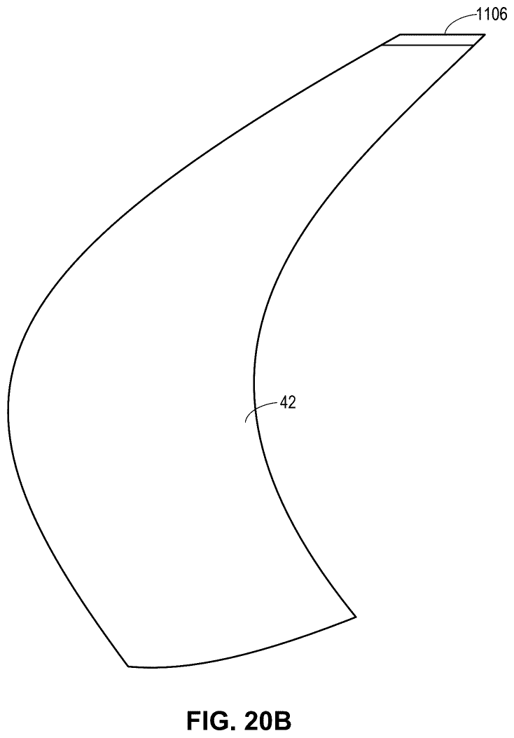

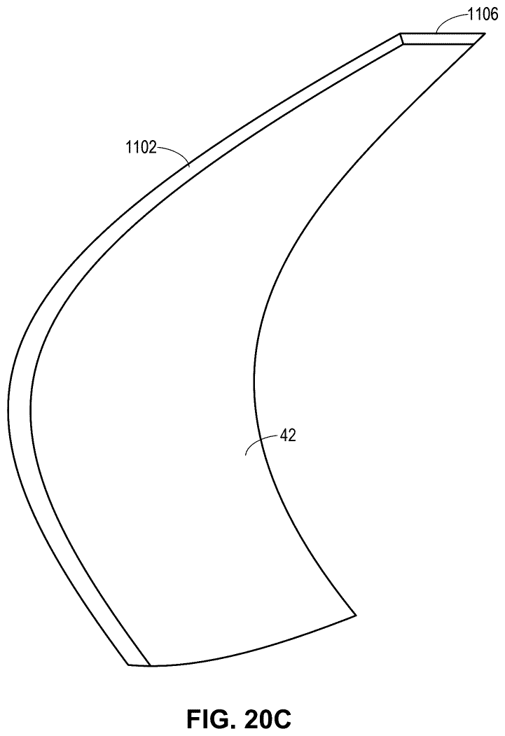

In some examples, a portion of the leading edge 302 is wavy (e.g., varies in position relative to an axial direction defined by the unducted fan propulsor 38) to enhance incidence tolerance at off-design conditions. In some other examples, the entire leading edge may be wavy, as discussed further in connection with FIGS. 19-20C. The amplitude and wavelength of these waves may be uniform over the span of the OGV 42 or may vary to provide optimal incidence tolerance. Incidence tolerance refers to a range across which an angle of incidence of an airfoil can vary during its operation without compromising aerodynamic performance of the airfoil. The angle of incidence is the difference between the incoming flow to the airfoil and the airfoil camber line (e.g., a difference in angle between airflow angle and airfoil meanline at the leading edge). In some examples, the leading edge may also be wavy in the circumferential direction.

A position along the leading edge 302 is defined by radial and axial locations along the radius of the OGV 42. If the OGV 42 has a variable pitch, the axial location at any radial location along the length of the OGV 42 depends on the pitch setting. With respect to variable pitch OGVs, discussion of the shape of the OGV 42 herein pertains to an orientation of the OGV 42 during cruise operations. That is, the OGV 42 is at the pitch setting that minimizes the power input to the fan for the thrust produced by the unducted thrust producing system. However, it should be understood that the discussion of the shape of the OGV 42 may also pertain to other design points. For example, the shape of the OGV 42 can reduce noise encountered during other operations, such as takeoff.

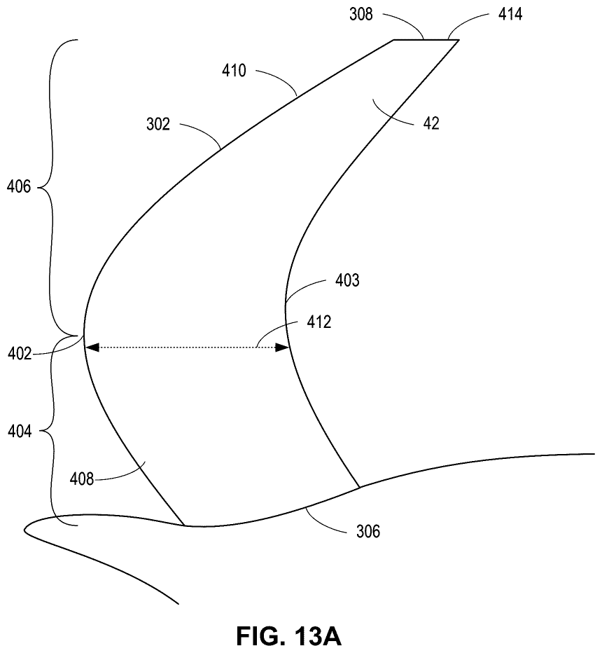

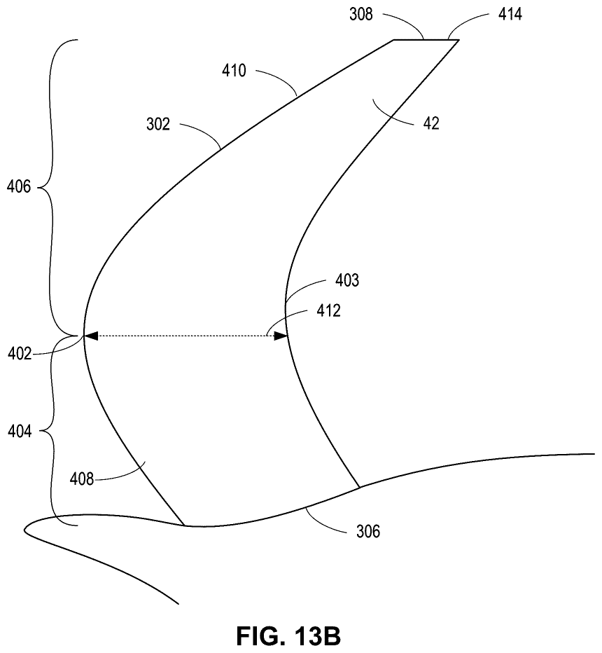

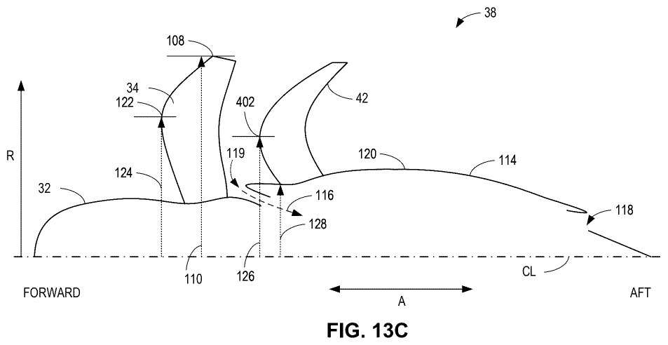

FIG. 13A illustrates a side view of the OGV 42. The OGV 42 includes a peak 402, a valley 403, a hub portion 404, and a tip portion 406. The hub portion 404 extends from the hub 306 to a radial distance defined by the peak 402. The tip portion 406 extends from the radial distance defined by the peak 402 to the tip 308.

As used herein, the “peak” of an airfoil (e.g., the peak 402 of the OGV 42) refers to a location on the airfoil at which the leading edge of the airfoil is positioned furthest forward in the axial direction A where the airfoil has a forward sweep in a hub portion (e.g., the hub portion 404) and an aft sweep in a tip portion (e.g., the tip portion 406). Accordingly, a remainder of the leading edge 302 of the OGV 42 outside (e.g., radially inward and radially outward) of the peak 402 is positioned aft of the peak 402. That is, the peak 402 is positioned forward of the leading edge 302 in the hub portion 404 and the tip portion 406. As such, the peak 402 defines a forwardmost portion (e.g., a forwardmost point) of the OGV 42 along the axial direction. The section of the OGV 42 at which the leading edge of the airfoil is positioned furthest forward in the axial direction A where the airfoil has a forward sweep in a hub portion (e.g., the hub portion 404) and an aft sweep in a tip portion (e.g., the tip portion 406) can also be referred to as the “belly section” or the “belly”.

As used herein, the “forwardmost point” or “forwardmost portion” of an OGV (e.g., the OGV 42) refers to the forwardmost point of the leading edge of the OGV when the OGV is in a cruise orientation. In some examples, the OGV is actuated or pitched for certain conditions, such as takeoff, cruise, and other conditions, and the “forwardmost point” or “forwardmost portion” of the OGV may not be the forwardmost point of the leading edge of the OGV in other (e.g., non-cruise) conditions.

As shown in the example of FIG. 13C, a peak 122 of the fan 34 is defined at a radius greater than or equal to a radius of the peak 402 of the OGV 42. Specifically, the fan 34 has a fan peak radius 124, and the OGV 42 has an OGV peak radius 126. The fan peak radius 124 is greater than or equal to the OGV peak radius 126. Further, the hub 306 of the OGV has an OGV hub radius 128.

A relationship of the OGV hub radius 128 at the leading edge 302 normalized by the fan tip radius 110 provides a normalized OGV hub radius (NOGVHR) that can be calculated using Equation 5 below:

$$NOGVHR = \frac{OGV hub radius 128}{fan tip radius 110} . \qquad ( Eq . 5 )$$

A relationship of the OGV peak radius 126 normalized by the fan tip radius 110 provides a normalized OGV peak radius (NOGVPR) that can be calculated using Equation 6 below:

$$NOGVPR = \frac{OGV peak radius 126}{fan tip radius 110} . \qquad ( Eq 6 )$$

In some examples, the NOGVPR herein is less than or equal to 0.4. In some such examples, the NOGVPR is greater than 1.1*NOGVHR (e.g., 110% of the NOGVHR). In some examples, the NOGVPR is less than or equal to 0.4. In some such examples, the NOGVPR is greater than or equal to 1.15*NOGVHR (e.g., 115% of the NOGVHR). In some examples, the NOGVPR is less than or equal to 0.4. In some such examples, the NOGVPR is greater than or equal to 1.2*NOGVHR (e.g., 120% of the NOGVHR). In some examples, the NOGVPR is less than or equal to 0.5. In some such examples, the NOGVPR is greater than 1.1*NOGVHR. In some examples, the NOGVPR is less than or equal to 0.5. In some such examples, the NOGVPR is greater than 1.15*NOGVHR. In some examples, the NOGVPR is less than or equal to 0.5. In some such examples, the NOGVPR is greater than 1.2*NOGVHR. In some examples, the NOGVPR is less than or equal to 0.55. In some such examples, the NOGVPR is greater than 1.1*NOGVHR. In some examples, the NOGVPR is less than or equal to 0.55. In some such examples, the NOGVPR is greater than 1.15*NOGVHR. In some examples, the NOGVPR is less than or equal to 0.55. In some such examples, the NOGVPR is greater than 1.2*NOGVHR. In some examples, the NOGVPR is less than or equal to 0.6. In some such examples, the NOGVPR is greater than 1.1*NOGVHR. In some examples, the NOGVPR is less than or equal to 0.6. In some such examples, the NOGVPR is greater than 1.15*NOGVHR. In some examples, the NOGVPR is less than or equal to 0.6. In some such examples, the NOGVPR is greater than 1.2*NOGVHR. In some examples, the NOGVPR is less than or equal to 0.65. In some such examples, the NOGVPR is greater than 1.1*NOGVHR. In some examples, the NOGVPR is less than or equal to 0.65 and greater than 1.15*NOGVHR. In some examples, the NOGVPR is less than or equal to 0.65. In some such examples, the NOGVPR is greater than 1.2*NOGVHR. In some examples, the NOGVPR is less than or equal to 0.68. In some such examples, the NOGVPR is greater than 1.1*NOGVHR. In some examples, the NOGVPR is less than or equal to 0.68. In some such examples, the NOGVPR is greater than 1.15*NOGVHR. In some examples, the NOGVPR is less than or equal to 0.68. In some such examples, the NOGVPR is greater than 1.2*NOGVHR. In some examples, the NOGVPR is less than or equal to 0.72. In some such examples, the NOGVPR is greater than 1.1*NOGVHR. In some examples, the NOGVPR is less than or equal to 0.72. In some such examples, the NOGVPR is greater than 1.15*NOGVHR. In some examples, the NOGVPR is less than or equal to 0.72. In some such examples, the NOGVPR is greater than 1.2*NOGVHR. In some examples, the NOGVPR is less than or equal to 0.75. In some such examples, the NOGVPR is greater than 1.1*NOGVHR. In some examples, the NOGVPR is less than or equal to 0.75. In some such examples, the NOGVPR is greater than 1.15*NOGVHR. In some examples, the NOGVPR is less than or equal to 0.75. In some such examples, the NOGVPR is greater than 1.2*NOGVHR. In some examples, the NOGVPR is less than or equal to 0.8. In some such examples, the NOGVPR is greater than 1.1*NOGVHR. In some examples, the NOGVPR is less than or equal to 0.8. In some such examples, the NOGVPR is greater than 1.15*NOGVHR. In some examples, the NOGVPR is less than or equal to 0.8. In some such examples, the NOGVPR is greater than 1.2*NOGVHR.

Similarly, a normalized fan peak radius (NFPR) can be calculated using Equation 7 below:

$$NFPR = \frac{fan peak radius 124}{fan tip radius 110} . \qquad ( Eq . 7 )$$

In examples disclosed herein, the NOGVPR is less than or equal to the NFPR. In some aspects, the NOGVPR is less than the NFPR. Specifically, reducing open fan noise includes maximizing fan sweep in the outer radial portions of the fan 34, where noise radiates most efficiently. Accordingly, the fan peak radius 124 is selected such as to maximize or otherwise increase sweep in the acoustically sensitive portion of the fan 34 to minimize the noise radiated by the fan loading. Configuring the NOGVPR to be less than the NFPR maximizes or otherwise increases the OGV sweep radially outward of the peak 402, where the fan wake interaction with the OGV 42 radiates most efficiently to the surroundings, which reduces the fan-wake OGV interaction noise and, in combination with the choice of NFPR, reduces the total noise produced by the unducted fan propulsor 38.

Returning to the illustrated example of FIGS. 13A-13B, the valley 403 defines a forwardmost portion of the trailing edge 304. More generally, as used herein, the “valley” of an airfoil (e.g., the valley 403 of the OGV 42) refers to a location on a trailing edge of the airfoil at which the trailing edge of the airfoil is positioned furthest forward in the axial direction A where the airfoil has a forward sweep in a hub portion (e.g., the hub portion 404) and an aft sweep in a tip portion (e.g., the tip portion 406). Thus, a remainder of the trailing edge 304 of the OGV 42 outside (e.g., radially inward and radially outward) of the valley 403 is positioned aft of the valley 403. In some examples, the peak 402 and the valley 403 are positioned at different radii. For example, a radius of the valley 403 can be greater than a radius of the peak 402, as shown in FIGS. 13A-13B.

In some examples, the OGV 42 is formed of metal. In some examples, the leading edge 302 of the OGV 42 is formed of metal. In some examples, a trailing portion of the OGV 42 (e.g., a portion of the OGV 42 aft of the metal at the leading edge 302, a portion of the OGV 42 extending from the trailing edge 304 to the metal of the leading edge 302 in the axial direction A) is formed of a composite material. In some examples, the composite material includes a braided fabric and/or braided fiber with a composite skin surrounding the braided fabric and/or fiber. In some examples, the composite material includes a polymer matrix composite (PMC), a ceramic matrix composite (CMC), metal matrix composite (MMC), carbon fiber, polymeric resin, thermoplastic, bismaleimide (BMI), polyimide materials, epoxy resin, glass fiber, and/or silicon matrix materials. In some examples, the composite materials includes metallic and non-metallic composites. For example, the composite material can include a unidirectional tape material and an epoxy resin matrix. In some examples, the composite material includes composite materials of the non-metallic type made of a material containing a fiber such as a carbonaceous, silica, metal, metal oxide, or ceramic fiber embedded in a resin material such as Epoxy, PMR15, BMI, PEED, etc. In some examples, the composite material includes fibers unidirectionally aligned into a tape that is impregnated with a resin, formed into a part shape, and cured via an autoclaving process or press molding to form a light-weight, stiff, relatively homogeneous article having laminates within. In some examples, the tip 308 includes a metal tip cap.

The hub portion 404 includes a forward sweep 408. As used herein, “forward sweep” refers to a tilt or angular orientation of a portion of the OGV 42 that positions the leading edge 302 further forward as a separation from the axis of rotation increases. That is, the leading edge 302 extends further forward in the hub portion 404 as the separation of the hub portion 404 from the axis of rotation (e.g., CL) increases in the radial direction R. In other words, an axial position of the leading edge 302 moves further forward in the hub portion 404 as separation from the axis of rotation CL in the radial direction R increases.

The tip portion 406 includes an aft sweep 410. As used herein, “aft sweep” refers to a tilt or angular orientation of a portion of the OGV 42 that positions the leading edge 302 further aft as a separation from the axis of rotation increases. As such, the leading edge 302 extends further aft in the tip portion 406 as the separation of the tip portion 406 from the axis of rotation increases in the radial direction R. That is, an axial position of the leading edge 302 moves further aft in the tip portion 406 as separation from the axis of rotation in the radial direction R increases.

The aft sweep of the tip portion 406 improves an efficiency and aerodynamics of the unducted fan propulsor 38 and reduces noise produced by the unducted propulsor 38. The forward sweep of the hub portion 404 limits an aft extension of the tip portion 406. In some examples, the forward sweep of the hub portion 404 enables the tip 308 to be positioned forward of a nacelle bulge 120 in the housing 114 between an inlet 119 and an exhaust 118 (within air flow 116 into the housing 114 as shown, for example, in FIG. 13C), which would otherwise reduce an efficiency of the unducted fan propulsor 38. In some examples, the forward sweep of the hub portion 404 reduces an area of the tip portion 406 that aligns with the nacelle bulge 120 to improve an efficiency of the unducted fan propulsor 38.

Additionally, as shown in the illustrated example of FIGS. 13A-13B, the chord length 310 of the OGV 42 varies with a radial distance from the axis of rotation CL. In the illustrated example of FIG. 13A, a maximum chord length 412 of the OGV 42 is defined in a portion of the hub portion 404. Specifically, the hub portion 404 has an increased chord length to provide the OGV 42 with support against higher aerodynamic loads encountered by the hub portion 404. In the illustrated example of FIG. 13B, the peak 402 has a same radius as the maximum chord length 412 of the OGV 42. The tip portion 406 encounters lower aerodynamic loads and includes a reduced chord length to limit skin friction losses encountered by the OGV 42 during cruise operations. Aerodynamic loads encountered by the tip 308 of the OGV 42 in the unducted fan propulsor 38 at cruise conditions are lower than OGVs in ducted engines, which enables the tip portion 406 to have the reduced chord length without negatively affecting the structural integrity of the OGV 42. In this example, the tip 308 includes a minimum chord length 414 of the OGV 42.

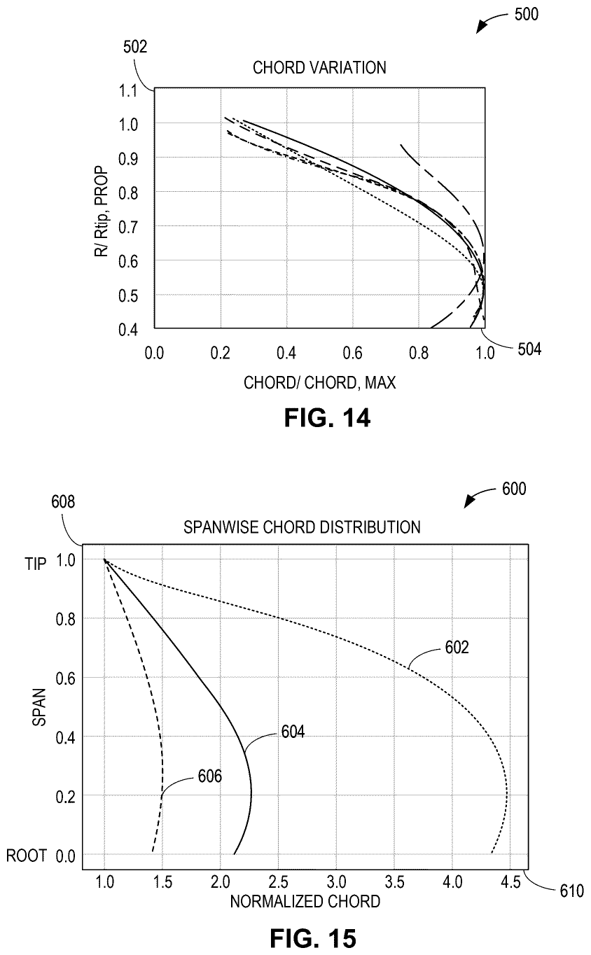

FIG. 14 is a plot 500 representative of a relationship between the chord length 310 of the OGV 42 as a function of a distance from the axis of rotation CL in the radial direction R. Specifically, ay-axis 502 of the plot 500 is representative of a ratio of (i) a distance between the axis of rotation and the particular radial location of the OGV 42 at which the chord length is observed to (ii) the fan tip radius 110 between the axis of rotation CL and the tip 108 of the fan 34 in the radial direction R (e.g., Rtip, prop). That is, the y-axis 502 represents the ratio of (i) the radius along the OGV 42 to (ii) the radius of the tip 108 of the fan 34. As such, the y-axis can be represented by Equation 8 below:

$${Y}_{1} = \frac{R}{Rtip , prop} . \qquad ( Eq . 8 )$$

In Equation 8, R is the radius along the OGV 42, and Rtip, prop is the radius of the tip 108 of the fan 34 (e.g., the fan tip radius 110). In some examples, the OGV 42 and the fan 34 have different heights. As such, the ratio of (i) the distance of the tip 308 of the OGV 42 from the axis of rotation CL to (ii) the fan tip radius 110 can be in a range that is greater than 0.75 and less than 1.1. Reference herein to the distance and/or the radius of the tip 308 of the OGV 42 from the axis of rotation CL refers to a distance between the leading edge 302 at the tip 308 and the axis of rotation CL. In the illustrated example of FIG. 14, the x-axis 504 is representative of a chord variation ratio of (i) a chord length at the particular radial location of the OGV 42 at which the chord length is observed (e.g., at a particular distance from the axis of rotation CL in the radial direction R) to (ii) a maximum chord length of the OGV 42. That is, the x-axis 504 represents the ratio of the chord along the OGV 42 to the maximum chord of the OGV 42. As such, the x-axis can be represented by Equation 9 below:

$${X}_{1} = \frac{chord}{chord , max} . \qquad ( Eq . 9 )$$

In Equation 9, chord is the chord length of the OGV 42 along the radial distance across which the OGV 42 extends, and chord, max is the maximum chord length of the OGV 42. As shown in the illustrated example of FIG. 14, a chord variation ratio of the minimum chord length of the OGV 42 (e.g., at the tip 308) to a maximum chord length of the OGV 42 (e.g., in the hub portion 404) is less than or equal to 0.25. In some examples, the chord variation ratio of the minimum chord length to the maximum chord length of the OGV 42 is less than or equal to 0.3. In some examples, the chord variation ratio of the minimum chord length to the maximum chord length of the OGV 42 is less than or equal to 0.4. In some examples, the chord variation ratio of the minimum chord length to the maximum chord length of the OGV 42 is less than or equal to 0.5. In some examples, the chord variation ratio of the minimum chord length to the maximum chord length of the OGV 42 is less than or equal to 0.6. In some examples, the chord variation ratio of the minimum chord length to the maximum chord length of the OGV 42 is less than or equal to 0.7. In some examples, the chord variation ratio of the minimum chord length to the maximum chord length of the OGV 42 is less than or equal to 0.8. The low chord variation ratios of the minimum chord length of the OGV 42 to the maximum chord length of the OGV 42 enables the OGV 42 to have structural support for high loads encountered in the hub portion 404 while also maximizing an aerodynamic performance of the tip portion 406 and, thus, an efficiency of the unducted propulsion system through a reduction in skin friction losses encountered by the OGV 42 in the tip portion 406.

To facilitate certain advantages, such as noise reduction, one or more of the OGVs 42 can be clipped such that the distance of the tip 308 from the axis of rotation CL is reduced. For a given OGV 42 example indicated by a curve in FIG. 14, clipping reduces the ratio indicated on the y-axis 502, thus increasing the ratio indicated on the x-axis 504. Thus, any of the curves for the example OGVs represented in the plot of FIG. 14 can be clipped (e.g., cut off or stopped at 0.7 on the y-axis, cut off or stopped at 0.8 on the y-axis, cut off or stopped at 0.9 on the y-axis) to represent reductions to the radius of tip 308. Accordingly, a ratio indicated on the x-axis 504 at 0.7, 0.8, and/or 0.9 on the y-axis can correspond to the ratio at the tip 308 of the OGV 42.

The plot of FIG. 14 shows the taper in chord from the max chord location (e.g., where the chord variation ratio indicated on the x-axis 504 equals 1.0) towards the tip 308. Another ratio of (i) the change in quantity represented on x-axis 504 to (ii) the change in the parameter represented on the y-axis 502, where the changes are taken from the maximum chord location to the tip 308, is a negative number. The magnitude of the negative number indicates an amount the chord decreases from the maximum chord location to the tip 308. As such, the ratio of the change in the x-axis 504 to the change in the y-axis 502 is less than −0.5. The ratio of the change in the x-axis 504 to the change in the y-axis 502 is preferably less than −1.0. The ratio of the change in the x-axis 504 to the change in the y-axis 502 is even more preferably less than −1.5.

Additionally, as shown in FIG. 5, the OGV 42 includes a ratio of (i) an absolute value of a change in a percentage of the chord length 310 from the maximum chord length to a chord length in the tip portion (e.g., the chord length 310 at the tip 308) to (ii) a radius difference between the maximum chord length and the third chord length normalized by a radius of the tip 108 of the fan 34 that is greater than 0.5. In some examples, the OGV 42 includes a ratio of (i) an absolute value of a change in a percentage of the chord length 310 from the maximum chord length to a chord length in the tip portion (e.g., the chord length 310 at the tip 308) to (ii) a radius difference between the maximum chord length and the third chord length normalized by a radius of the tip 108 of the fan 34 that is greater than 1.0. In some examples, the OGV 42 includes a ratio of (i) an absolute value of a change in a percentage of the chord length 310 from the maximum chord length to a chord length in the tip portion (e.g., the chord length 310 at the tip 308) to (ii) a radius difference between the maximum chord length and the third chord length normalized by a radius of the tip 108 of the fan 34 that is greater than 1.5.

FIG. 14 is another plot 600 representative of a relationship between the chord length 310 of the OGV 42 as a function of a span of the OGV 42 in the radial direction R. Specifically, some OGVs 42 can be clipped to reduce a height of the OGV 42 in the radial direction R (e.g., a separation of the tip 308 from the axis of rotation CL). The plot 600 provides the relationship between the chord length 310 of the OGV 42 as a function of a span of the OGV 42 in the radial direction R for a baseline OGV 602 (e.g., a nominal OGV), a first clipped OGV 604, and a second clipped OGV 606. Specifically, a tip (e.g., the tip 308) of the first clipped OGV 604 is positioned closer to the axis of rotation CL than a tip (e.g., the tip 308) of the baseline OGV 602 in the radial direction R, and a tip of the second clipped OGV 606 is positioned closer to the axis of rotation CL than the tip of the first clipped OGV 604 in the radial direction R. In some examples, the unducted fan propulsor 38 includes the baseline OGV 602, the first clipped OGV 604, and/or the second clipped OGV 606.

In the illustrated example of FIG. 15, a y-axis 608 of the plot 600 is representative of a span of the OGVs 602, 604, 606. Along the y-axis 608, 0.0 is a hub (e.g., a root) at which the OGV 602, 604, 606 couples to the nacelle, and 1.0 is a tip (e.g., the tip 308) of the OGV 602, 604, 606. Accordingly, the y-axis 608 (Y2) can be represented by Equation 10 below:

$${Y}_{2} = \frac{radius}{radius , max} . \qquad ( Eq . 10 )$$

In Equation 10 the radius is the radius across which the OGV 42 extends (e.g., the distance across which the OGV 42 extends between the axis of rotation CL and the tip 308 of the OGV 42), and the radius, max is the radius of the tip 308 of the OGV 42 (e.g., the distance between the axis of rotation CL and the tip 308). The x-axis 610 of the plot 600 is representative of a normalized chord length of the OGVs 602, 604, 606. The normalized chord length is representative of a ratio between a chord length of the OGV 602, 604, 606 at the particular span location along the y-axis 608 relative to a minimum chord length of the OGV 602, 604, 606. Accordingly, the x-axis (X2) 610 can be represented by Equation 11 below:

$${X}_{2} = \frac{chord}{chord , minimum} . \qquad ( Eq . 11 )$$

In Equation 11, chord is the chord length of the OGV 42 along the radial distance across which the OGV 42 extends, and chord, minimum is the minimum chord length of the OGV 42 (e.g., at the tip 308). In the illustrated example of FIG. 15, the maximum chord length for the OGVs 602, 604, 606 occurs at approximately 0.2 of the span. The baseline OGV 602 has a maximum chord length greater than 4 times the minimum chord length at the tip (e.g., the tip 308). The first clipped OGV 604 has a maximum chord length greater than 2 times the minimum chord length at the tip (e.g., the tip 308). The second clipped OGV 606 has a maximum chord length approximately 1.5 times the minimum chord length at the tip (e.g., the tip 308). The difference between the maximum chord length to minimum chord length ratios of the OGVs 602, 604, 606 is a result of the tips of the OGVs 602, 604, 606 having a greater chord length when clipped.

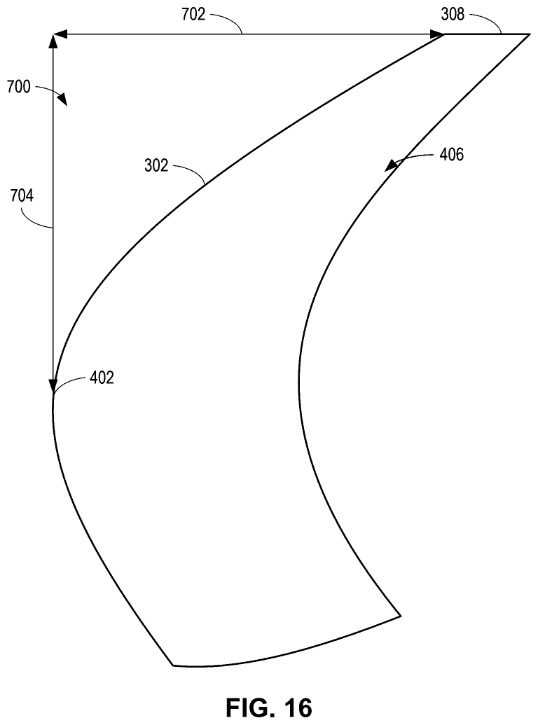

FIG. 16 is an isolated view of the OGV 42. The illustrated example of FIG. 16 will be utilized for discussion of a leading edge aft sweep 700 of the tip portion 406 of the OGV 42. In the illustrated example of FIG. 16, the leading edge aft sweep 700 along the leading edge 302 of the tip portion 406 is characterized by a ratio of (i) an axial separation 702 between the leading edge 302 of the tip portion 406 and the peak 402 in the axial direction A to (ii) a radial separation 704 from the peak 402 to the tip 308. Accordingly, the leading edge aft sweep 700 from the peak 402 to the tip 308 can be represented by a ratio of (i) a first distance from the peak 402 to the leading edge 302 at the tip 308 in the axial direction A to (ii) a second distance from the peak 402 to the tip 308 in the radial direction R. Thus, the leading edge aft sweep 700 can be represented by a leading edge sweep characteristic ratio (LESCR) defined by Equation 12 below:

$$LESCR = \frac{axial separation 702}{radial separation 704} . \qquad ( Eq . 12 )$$

As shown, the leading edge aft sweep 700 results in an axial separation between the peak 402 and the leading edge 302 of the tip portion 406 that increases with increased separation from the axis of rotation CL in the radial direction R. In some examples, the leading edge aft sweep 700 causes the ratio in a portion of the tip portion 406 to be greater than or equal to 0.1. In some examples, the leading edge aft sweep 700 causes the ratio in a portion of the tip portion 406 to be greater than or equal to 0.2. In some examples, the leading edge aft sweep 700 causes the ratio in a portion of the tip portion 406 to be greater than or equal to 0.3. In some examples, the leading edge aft sweep 700 causes the ratio in a portion of the tip portion 406 to be greater than or equal to 0.5. In some examples, the leading edge aft sweep 700 causes the ratio in a portion of the tip portion 406 to be greater than or equal to 0.7. In some examples, the leading edge aft sweep 700 causes the ratio in a portion of the tip portion 406 to be greater than or equal to 0.9. In some examples, the leading edge aft sweep 700 causes the ratio in a portion of the tip portion 406 to be greater than or equal to 1.1. In some examples, the leading edge aft sweep 700 causes the ratio in a portion of the tip portion 406 to be greater than or equal to 1.4. In some examples, the leading edge aft sweep 700 causes the ratio in a portion of the tip portion 406 (e.g., at the tip 308) to be greater than or equal to 1.7. In some examples, the leading edge aft sweep 700 causes the ratio in a portion of the tip portion 406 (e.g., at the tip 308) to be greater than or equal to 1.8.

The leading edge aft sweep 700 can also be quantified in degrees (°). For example, the leading edge aft sweep 700 (e.g., an average angle of the leading edge aft sweep 700) is equivalent to or between 10° and 60°. The leading edge aft sweep 700 in degrees can be determined by taking the arctangent of the LESCR and converting to degrees. Additionally or alternatively, the leading edge aft sweep 700 in degrees can be determined by measuring an angle between a straight line from the peak 402 to the leading edge 302 at the tip 308 and the radial direction R (FIG. 1) (e.g., the radial separation 704 of FIG. 7). Table 1 below shows how the degree quantification corresponds with the LESCR.

TABLE 1

| LESCR | Sweep (°) |
|---|---|
| 0.18 | 10 |
| 1.7 | 60 |

The example ratio values provided above generally correspond to an unducted propulsion system (e.g., the unducted fan propulsor 38) that cruises at approximately Mach 0.8. The ratios can increase with an increase in the cruise Mach and/or an increase in the thrust coefficient. Additionally, the ratios can increase with an increase in the thrust coefficient.

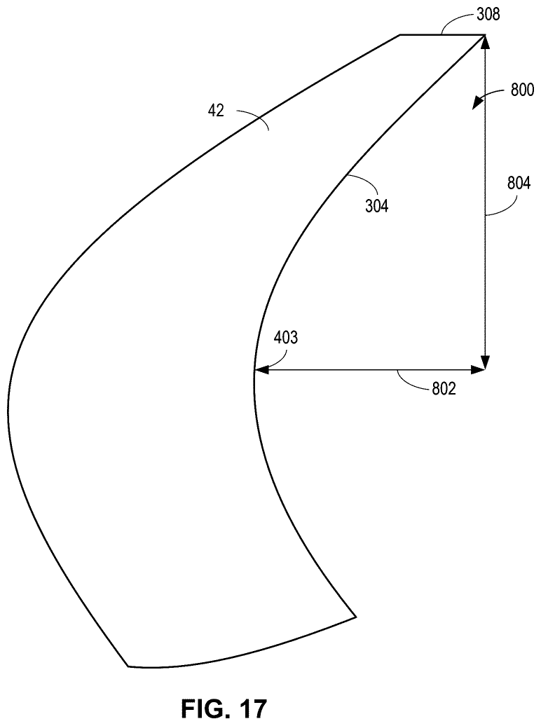

FIG. 17 is another isolated view of the OGV 42. The illustrated example of FIG. 17 will be utilized for discussion of a trailing edge aft sweep 800 of the trailing edge 304 between the valley 403 and the tip 308. In the illustrated example of FIG. 17, the trailing edge aft sweep 800 along the trailing edge 304 is characterized by a ratio of (i) an axial separation 802 between the valley 403 and the trailing edge 304 at the tip 308 in the axial direction A to (ii) a radial separation 804 between the valley 403 and the trailing edge 304 at the tip 308 in the radial direction R. Accordingly, the trailing edge aft sweep 800 from the valley 403 to the tip 308 can be represented by a ratio of (i) a first distance (e.g., a third distance) from the valley 403 to the trailing edge 304 at the tip 308 in the axial direction A to (ii) a second distance (e.g., a fourth distance) from the valley 403 to the tip 308 in the radial direction R. Thus, the trailing edge aft sweep 800 can be represented by a trailing edge sweep characteristic ratio (TESCR) defined by Equation 13 below:

$$TESCR = \frac{axial separation 802}{radial separation 804} \qquad ( Eq . 13 )$$

The TESCR is greater than or equal to 0.1 and less than or equal to 1.8. Additionally, the TESCR is less than or equal to the LESCR.

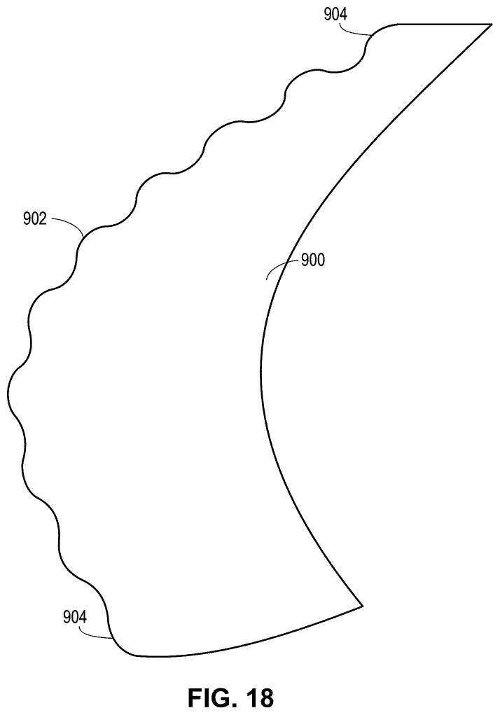

FIG. 18 illustrates another example OGV 900 including a first example wavy leading edge 902. The wavy leading edge 902 enhances incidence tolerance at off-design conditions (e.g., non-cruise). In the illustrated example of FIG. 18, the wavy leading edge 902 includes convex portions 904 contiguous with the hub 306 and the tip 308.

FIG. 19 illustrates another example OGV 1000 including a second example wavy leading edge 1002. The wavy leading edge 1002 enhances incidence tolerance at off-design conditions (e.g., takeoff). In the illustrated example of FIG. 19, the wavy leading edge 1002 includes concave portions 1004 contiguous with the hub 306 and the tip 308. In some examples, the OGV 1000 includes one of the convex portions 904 contiguous with the hub 306 instead of one of the concave portions 1004. In some examples, the OGV 1000 includes one of the convex portions 904 contiguous with the tip 308 instead of one of the concave portions 1004.

The amplitude and wavelength of waves in the first wavy leading edge 902 of FIG. 18 and the second wavy leading edge 1002 of FIG. 19 may be uniform over the span of the OGV 42 or may vary to provide the optimal incidence tolerance. As mentioned above, the optimal incidence tolerance refers to a range across which an angle of incidence of an airfoil can vary during its operation without compromising aerodynamic performance of the airfoil. In some examples, the first wavy leading edge 902 of FIG. 18 and/or the second wavy leading edge 1002 of FIG. 19 may also be wavy in the circumferential direction. The example OGV 900 of FIG. 18 is preferable to the example OGV 1000 of FIG. 19 to enable the OGV to have a leading edge forward sweep contiguous with the hub 306 and a leading edge aft sweep contiguous with the tip 308.

While provided with a different reference number as a result of a difference between shapes of the leading edge 302 of the OGV 42 of FIGS. 3-5B and 12A-17, the first wavy leading edge 902 of the OGV 900 of FIG. 18, and the second wavy leading edge 1002 of the OGV 1000 of FIG. 19, it should be understood that the first wavy leading edge 902 or the second wavy leading edge 1002 can be incorporated in the OGV 42 (i.e., in place of a non-wavy shape of the leading edge 302) and the unducted fan propulsor 38. Moreover, the OGV 42 can maintain other features discussed herein in connection with FIGS. 1-17 above and FIGS. 20A-C below with incorporation of the first wavy leading edge 902 or the second wavy leading edge 1002.

FIG. 20A illustrates an example implementation of the OGV 42 including a metal leading portion 1102 (e.g., a metal leading edge) and a composite trailing portion 1104 (e.g., a composite trailing edge). The metal leading portion 1102 of the OGV 42 is formed of a metal. The composite trailing portion 1104 of the OGV 42 is formed of a composite material. The metal leading portion 1102 extends from the leading edge 302 towards the trailing edge 304. Thus, the metal leading portion 1102 defines a leading portion of the OGV 42 (e.g., a leading portion of the chord length 310 (FIG. 12)), and the composite trailing portion 1104 defines a trailing portion of the OGV 42 (e.g., a trailing portion of the chord length 310) distinct from and contiguous with the metal leading portion. Thus, the metal occupies a portion of a length of the OGV 42 in the axial direction A from the leading edge 302. The metal leading portion 1102 provides the leading edge 302 with erosion protection while reducing a weight of the OGV 42 relative to the OGV 42 being formed of metal in the composite trailing portion 1104 in addition to the metal leading portion 1102.

FIG. 20B illustrates another example implementation of the OGV 42 including a metal tip cap 1106 that occupies a portion of a height of the OGV 42 in the radial direction R from the tip 308 (e.g., the outer radial surface of the OGV 42). That is, the metal tip portion extends from the tip 308 towards the hub 306. In FIG. 20B, the metal tip cap 1106 includes a metal, and a portion of the OGV 42 outside of the metal tip cap 1106 includes a non-metal (e.g., a composite). The metal tip cap 1106 provides the tip 308 with increased protection against collision (e.g., bird strike). Further, as the metal tip cap 1106 is smaller than the metal leading portion 1102 (FIG. 20A), the example implementation of the OGV 42 in FIG. 20B has a reduced weight relative to the example implementation of the OGV 42 in FIG. 20A.

FIG. 20C illustrates another example implementation of the OGV 42 including both the metal leading portion 1102 and the metal tip cap 1106. As such, the example implementation of the OGV 42 of FIG. 20C provides increased protection against debris impact and increased erosion protection at the leading edge 302. However, the example implementation of the OGV 42 of FIG. 20C has an increased weight relative to the example implementations of the OGV 42 of FIGS. 20A and 20B.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

From the foregoing, it will be appreciated that example unducted propulsion systems and associated outlet guide vanes have been disclosed that improve an efficiency and aerodynamics of an engine. Further, the example unducted propulsion systems and associated outlet guide vanes disclosed herein can reduce noise produced by unducted propulsion systems.

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and 0 is between 187° and 340°, and wherein RL/D and θ of the P of the unducted fan propulsor adhere to the following expressions:

$$\frac{R L}{D} + \frac{( \begin{matrix}\sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( \begin{matrix}- \sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} < 0$$

In the preceding clause, 0.254<RL/D<1.86 and 0 is between 199° and 306°, and the P of the unducted fan propulsor is defined by the following expressions:

$$\frac{R L}{D} + \frac{( \begin{matrix}\sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * sin ( θ ) + 0.23119 * cos ( θ )\end{matrix} )}{0864 \; 9 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * {sin}^{2} ( θ ) + 0.23119 * {cos}^{2} ( θ )\end{matrix} )}{0.8649 * {sin}^{2} ( θ ) + 0.6084 * {cos}^{2} ( θ )} < 0$$

In any of the two preceding clauses, 0.369<RL/D<1.43 and θ is between 204° and 291°, and the P of the unducted fan propulsor is defined by the following expressions:

$$\frac{R L}{D} + \frac{( \begin{matrix}\sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * sin ( θ ) + 0.23119 * {cos}^{2} ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * sin ( θ ) + 0.23119 * cos ( θ )\end{matrix} )}{0.8649 * {sin}^{2} ( θ ) + 0.6084 * {cos}^{2} ( θ )} < 0$$

In any of the three preceding clauses: 0.477<RL/D<0.9455 and θ is between 211° and 274°, and the P of the unducted fan propulsor is defined by the following expressions:

$$\frac{R L}{D} + \frac{( \begin{matrix}\sqrt{\begin{matrix}( 0.01069156 * [ 0.036 * {sin}^{2} ( θ ) - 0.3485 * {cos}^{2} ( θ ) + \\ 0.5418 * sin ( θ ) * cos ( θ ) ]\end{matrix} +} \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}( 0.01069156 * [ 0.036 * {sin}^{2} ( θ ) - 0.3485 * {cos}^{2} ( θ ) + \\ 0.5418 * sin ( θ ) * cos ( θ ) ]\end{matrix} +} \\ 0.139167 * sin ( θ ) + 0.020812 * cos ( θ )\end{matrix} )}{0.2209 * {sin}^{2} ( θ ) + 0.0484 * {cos}^{2} ( θ )} < 0$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and 0 is between 187° and 340°; and wherein RL/D and θ of the P of the unducted fan propulsor adhere to the following expressions:

$$\frac{R L}{D} \frac{( \begin{matrix}\sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( \begin{matrix}- \sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} < 0$$

The aircraft of Clause 6, wherein:
0.254<RL/D<1.86 and θ is between 199° and 306°, and
the P of the unducted fan propulsor is defined by the following expressions:

$$\frac{R L}{D} + \frac{( \begin{matrix}\sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}( 0.52621 * [ 0.7205 * {sin}^{2} ( θ ) - 0.352 * {cos}^{2} ( θ ) + \\ 0.74 48 * sin ( θ ) * cos ( θ ) ]\end{matrix} +} \\ 0.8476 * sin ( θ ) + 0.23119 * cos ( θ )\end{matrix} )}{0.8649 * {sin}^{2} ( θ ) + 0.6084 * {cos}^{2} ( θ )} < 0$$

The aircraft of Clause 6, wherein:
0.369<RL/D<1.43 and θ is between 204° and 291°, and
the P of the unducted fan propulsor is defined by the following expressions:

$$\frac{R L}{D} + \frac{( \begin{matrix}\sqrt{\begin{matrix}( 0.09923 * [ 0.2964 * {sin}^{2} ( θ ) - 0.36 * {cos}^{2} ( θ ) + \\ 0.66 * sin ( θ ) * cos ( θ ) ]\end{matrix} +} \\ 0.36756 * sin ( θ ) + 0.0891 * cos ( θ )\end{matrix} )}{0.49 * {sin}^{2} ( θ ) + 0.2025 * {cos}^{2} ( θ )} > 0$$

$$and$$

$$\frac{R L}{D} + \frac{( \begin{matrix}- \sqrt{\begin{matrix}( 0.09923 * [ 0.2964 * {sin}^{2} ( θ ) - 0.36 * {cos}^{2} ( θ ) + \\ 0.66 * sin ( θ ) * cos ( θ ) ]\end{matrix} +} \\ 0.36756 * sin ( θ ) + 0.0891 * cos ( θ )\end{matrix} )}{0.49 * {sin}^{2} ( θ ) + 0.2025 * {cos}^{2} ( θ )} < 0$$

The aircraft of Clause 6, wherein:
0.477<RL/D<0.9455 and θ is between 211° and 274°, and
the P of the unducted fan propulsor is defined by the following expressions:

$$\frac{R L}{D} + \frac{( \begin{matrix}\sqrt{\begin{matrix}( 0.01069156 * [ 0.036 * {sin}^{2} ( θ ) - 0.3485 * {cos}^{2} ( θ ) + \\ 0.5418 * sin ( θ ) * cos ( θ ) ]\end{matrix} +} \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}( 0.01069156 * [ 0.036 * {sin}^{2} ( θ ) - 0.3485 * {cos}^{2} ( θ ) + \\ 0.5418 * sin ( θ ) * cos ( θ ) ]\end{matrix} +} \\ 0.139167 * sin ( θ ) + 0.020812 * cos ( θ )\end{matrix} )}{0.2209 * {sin}^{2} ( θ ) + 0.0484 * {cos}^{2} ( θ )} < 0$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 1870 and 342.°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising:
a fuselage;
a pair of horizontal stabilizers extending relative to the fuselage,
two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to deliver torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

An aircraft comprising: a fuselage; a pair of wings extending from the fuselage, two or more unducted fan propulsors, each of the unducted fan propulsors mounted relative to one of the wings on a high pressure side thereof, the respective unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the respective unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8; a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

The aircraft of any preceding clause, wherein 0.15≤RL/D.

The aircraft of any preceding clause, wherein 0.35≤RL/D, and preferably RL/D is about 0.72.

The aircraft of any preceding clause, wherein θ is between 198° and 310°, and preferably between 205° and 285°.

The aircraft of any preceding clause, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

The aircraft of any preceding clause, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of any preceding clause, wherein the unducted fan propulsor is undermounted to the airfoil with one or more intermediate structures.

The aircraft of any preceding clause, wherein the P of the unducted fan propulsor is variable to accommodate different operating conditions.

The aircraft of any preceding clause, wherein the second chord length is a maximum chord length of the outlet guide vane, and wherein the hub portion includes the maximum chord length or the peak is defined at a same radius as the maximum chord length.

The aircraft of any preceding clause, wherein the ratio of the first chord length to the second chord length is less than or equal to 0.6.

The aircraft of any preceding clause, wherein the ratio of the first chord length to the second chord length is less than or equal to 0.4.

The aircraft of any preceding clause, wherein the ratio of the first chord length to the second chord length is less than or equal to 0.25.

The aircraft of any preceding clause, wherein the outlet guide vane further includes a leading edge and a trailing portion, wherein the leading edge is formed of a metal, wherein the trailing portion is formed of a composite material, and wherein an outer radial surface of the tip portion of the outlet guide vane includes a metal tip cap.

The aircraft of any preceding clause, wherein the tip portion of the outlet guide vane further includes a tip, wherein the ratio is a chord variation ratio, wherein a sweep from the peak to the tip is characterized by a leading edge sweep characteristic ratio of (i) a first distance from the peak to a leading edge of the tip in an axial direction defined by the unducted propulsion system to (ii) a second distance from the peak to the tip in the radial direction, wherein the leading edge sweep characteristic ratio is greater than or equal to 0.1 and less than or equal to 1.8.

The aircraft of any preceding clause, wherein the leading edge sweep characteristic ratio is greater than or equal to 0.5 and less than or equal to 1.8.

The aircraft of any preceding clause, wherein the leading edge sweep characteristic ratio is greater than or equal to 0.9 and less than or equal to 1.8.

The aircraft of any preceding clause, wherein the leading edge sweep characteristic ratio is greater than or equal to 1.4 and less than or equal to 1.8.

An aircraft comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8; a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The aircraft of any preceding clause, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any preceding clause, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any preceding clause, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

The aircraft of any preceding clause, wherein the second chord length is a maximum chord length of the outlet guide vane, and wherein the hub portion includes the maximum chord length or the peak is defined at a same radius as the maximum chord length.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8; a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{R L}{D} \frac{( \begin{matrix}\sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0. \text{?}\end{matrix} )}{1.96 * {sin}^{2} ( θ ) + 0.7225 * {cos}^{2} ( θ )} > 0$$

$$and$$

$$\frac{R L}{D} \frac{( \begin{matrix}- \sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

$$\text{?} \text{indicates text missing or illegible when filed}$$

The aircraft of any preceding clause, wherein the second chord length is a maximum chord length of the outlet guide vane, and wherein the hub portion includes the maximum chord length or the peak is defined at a same radius as the maximum chord length.

An unducted propulsion system comprising a fan, and an outlet guide vane downstream of the fan, the outlet guide vane including a hub portion, a tip portion, and a belly section between the hub portion and the tip portion in a radial direction defined by the unducted propulsion system, the hub portion including a forward sweep, the tip portion including an aft sweep, wherein the belly section includes a forwardmost point of the outlet guide vane, wherein at least a portion of the tip portion includes a first chord length, wherein the outlet guide vane includes a second chord length, and wherein a ratio of the first chord length to the second chord length is less than 0.8.

The unducted propulsion system of any preceding clause, wherein the second chord length is a maximum chord length of the outlet guide vane, and wherein the hub portion includes the maximum chord length.

The unducted propulsion system of any preceding clause, wherein the second chord length is a maximum chord length of the outlet guide vane, and wherein the hub portion includes the maximum chord length or the peak is defined at a same radius as the maximum chord length.

The unducted propulsion system of any preceding clause, wherein the fan includes a tip, wherein the tip is positioned a first distance from an axis of rotation of the fan in a radial direction defined by the unducted propulsion system, wherein the maximum chord length is positioned a second distance from the axis of rotation of the fan in the radial direction, and wherein the second distance is approximately half of the first distance.

The unducted propulsion system of any preceding clause, wherein the fan includes a tip, wherein the tip is positioned at a first distance from an axis of rotation of the fan in a radial direction defined by the unducted propulsion system, wherein the first chord length is positioned at a second distance from the axis of rotation of the fan in the radial direction, and wherein the second distance is greater than or equal to 75% of the first distance.

The unducted propulsion system of any preceding clause, wherein the ratio is less than or equal to 0.7.

The unducted propulsion system of any preceding clause, wherein the ratio is less than or equal to 0.6.

The unducted propulsion system of any preceding clause, wherein the ratio is less than or equal to 0.5.

The unducted propulsion system of any preceding clause, wherein the ratio is less than or equal to 0.4.

The unducted propulsion system of any preceding clause, wherein the ratio is less than or equal to 0.3.

The unducted propulsion system of any preceding clause, wherein the ratio is less than or equal to 0.25.

The unducted propulsion system of any preceding clause, wherein the ratio is a first ratio, wherein a second ratio of a maximum chord length of the outlet guide vane to a minimum chord length of the outlet guide vane is at least 1.5.

The unducted propulsion system of any preceding clause, wherein the second ratio is at least 2.0.

The unducted propulsion system of any preceding clause, wherein the second ratio is at least 2.5.

The unducted propulsion system of any preceding clause, wherein the second ratio is at least 3.0.

The unducted propulsion system of any preceding clause, wherein the second ratio is at least 3.5.

The unducted propulsion system of any preceding clause, wherein the second ratio is at least 4.0.

The unducted propulsion system of any preceding clause, wherein the second ratio is at least 4.4.

The unducted propulsion system of any preceding clause, wherein the outlet guide vane includes a leading edge and a trailing portion, wherein the leading edge is formed of a metal, wherein the trailing portion is formed of a composite material.

The unducted propulsion system of any preceding clause, wherein an outer radial surface of the tip portion of the outlet guide vane includes a metal tip cap.

The unducted propulsion system of any preceding clause, wherein an outer radial edge of the tip portion defines a tip of the outlet guide vane, wherein the ratio is a chord variation ratio, wherein a sweep from the belly section to the tip is characterized by a leading edge sweep characteristic ratio of (i) a first distance from the forwardmost point to a leading edge of the tip in an axial direction defined by the unducted propulsion system to (ii) a second distance from the belly portion to the tip in the radial direction, wherein the leading edge sweep characteristic ratio is greater than or equal to 0.1 and less than or equal to 1.8.

The unducted propulsion system of any preceding clause, wherein the outlet guide vane includes a tip, wherein the ratio is a chord variation ratio, wherein a sweep from the peak to the tip is characterized by a leading edge sweep characteristic ratio of (i) a first distance from the peak to a leading edge of the tip in an axial direction defined by the unducted propulsion system to (ii) a second distance from the peak to the tip in the radial direction, wherein the leading edge sweep characteristic ratio is greater than or equal to 0.1 and less than or equal to 1.8.

The unducted propulsion system of any preceding clause, wherein the leading edge sweep characteristic ratio is greater than or equal to 0.2.

The unducted propulsion system of any preceding clause, wherein the leading edge sweep characteristic ratio is greater than or equal to 0.3.

The unducted propulsion system of any preceding clause, wherein the leading edge sweep characteristic ratio is greater than or equal to 0.4.

The unducted propulsion system of any preceding clause, wherein the leading edge sweep characteristic ratio is greater than or equal to 0.5.

The unducted propulsion system of any preceding clause, wherein the leading edge sweep characteristic ratio is greater than or equal to 0.6.

The unducted propulsion system of any preceding clause, wherein the leading edge sweep characteristic ratio is greater than or equal to 0.7.

The unducted propulsion system of any preceding clause, wherein the leading edge sweep characteristic ratio is greater than or equal to 0.8.

The unducted propulsion system of any preceding clause, wherein the leading edge sweep characteristic ratio is greater than or equal to 0.9.

The unducted propulsion system of any preceding clause, wherein the leading edge sweep characteristic ratio is greater than or equal to 1.0.

The unducted propulsion system of any preceding clause, wherein the leading edge sweep characteristic ratio is greater than or equal to 1.1.

The unducted propulsion system of any preceding clause, wherein the leading edge sweep characteristic ratio is greater than or equal to 1.2.

The unducted propulsion system of any preceding clause, wherein the leading edge sweep characteristic ratio is greater than or equal to 1.3.

The unducted propulsion system of any preceding clause, wherein the leading edge sweep characteristic ratio is greater than or equal to 1.4.

The unducted propulsion system of any preceding clause, wherein the leading edge sweep characteristic ratio is greater than or equal to 1.5.

The unducted propulsion system of any preceding clause, wherein the leading edge sweep characteristic ratio is greater than or equal to 1.6.

The unducted propulsion system of any preceding clause, wherein the leading edge sweep characteristic ratio is greater than or equal to 1.7.

The unducted propulsion system of any preceding clause, wherein the outlet guide vane is a first outlet guide vane of an outlet guide vane assembly, wherein the ratio is a first chord variation ratio, and wherein the outlet guide vane assembly includes a second outlet guide vane downstream of the fan.

The unducted propulsion system of any preceding clause, wherein the second outlet guide vane includes a third chord length and a fourth chord length, wherein the third chord length is at a tip of the second outlet guide vane, and wherein a second chord variation ratio of the third chord length to the fourth chord length is approximately equivalent to the first chord variation ratio.

The unducted propulsion system of any preceding clause, wherein the fourth chord length is a maximum chord length of the second outlet guide vane.

The unducted propulsion system of any preceding clause, wherein the second outlet guide vane includes a third chord length and a fourth chord length, wherein the third chord length is at a tip of the second outlet guide vane, and wherein a second chord variation ratio of the third chord length to the fourth chord length is different than the first chord variation ratio.

The unducted propulsion system of any preceding clause, wherein the fourth chord length is a maximum chord length of the second outlet guide vane.

The unducted propulsion system of any preceding clause, wherein the outlet guide vane is a first outlet guide vane that has a first radial height, further including a second outlet guide vane that has a second radial height, wherein the second radial height is different than the first radial height.

The unducted propulsion system of any preceding clause, wherein the unducted propulsion system provides a cruise flight Mach greater than 0.7.

The unducted propulsion system of any preceding clause, wherein the unducted propulsion system provides a cruise flight Mach greater than 0.75.

The unducted propulsion system of any preceding clause, wherein the unducted propulsion system provides a cruise flight Mach greater than 0.78.

The unducted propulsion system of any preceding clause, wherein the unducted propulsion system provides a thrust coefficient greater than 0.06.

The unducted propulsion system of any preceding clause, wherein a forwardmost portion of the outlet guide vane is at a radius normalized by a tip radius of the fan that is less than or equal to 0.5.

The unducted propulsion system of any preceding clause, wherein a forwardmost portion of the outlet guide vane is at a radius normalized by a tip radius of the fan is less than or equal to 0.55.

The unducted propulsion system of any preceding clause, wherein a forwardmost portion of the outlet guide vane is at a radius normalized by a tip radius of the fan is less than or equal to 0.6.

The unducted propulsion system of any preceding clause, wherein the ratio is a chord variation ratio, wherein the outlet guide vane includes a second ratio of (i) an absolute value of a change in a percentage of the chord length from a maximum chord length to a third chord length in the tip portion to (ii) a radius difference between the maximum chord length and the third chord length normalized by a radius of a tip of the fan that is greater than 0.5.

The unducted propulsion system of any preceding clause, wherein the ratio is a chord variation ratio, wherein the outlet guide vane includes a second ratio of (i) an absolute value of a change in a percentage of the chord length from a maximum chord length to a third chord length in the tip portion to (ii) a radius difference between the maximum chord length and the third chord length normalized by a distance between a tip of the fan that is greater than 1.0.

The unducted propulsion system of any preceding clause, wherein the ratio is a chord variation ratio, wherein the outlet guide vane includes a second ratio of (i) an absolute value of a change in a percentage of the chord length from a maximum chord length to a third chord length in the tip portion to (ii) a radius difference between the maximum chord length and the third chord length normalized by a distance between a tip of the fan that is greater than 1.5.

The unducted propulsion system of any preceding clause, wherein the fan includes a tip, wherein the tip of the fan is positioned a first distance from an axis of rotation of the fan, wherein the belly section is positioned a second distance from the axis of rotation, and wherein the second distance is in a range of 50% to 60% of the first distance.

The unducted propulsion system of any preceding clause, wherein the fan includes a tip, wherein the tip of the fan is positioned a first distance from an axis of rotation of the fan, wherein the belly section is positioned a second distance from the axis of rotation, and wherein the second distance is in a range of 50% to 65% of the first distance.

The unducted propulsion system of any preceding clause, wherein the fan includes a tip, wherein the tip of the fan is positioned a first distance from an axis of rotation of the fan, wherein the belly section is positioned a second distance from the axis of rotation, and wherein the second distance is in a range of 50% to 70% of the first distance.

The unducted propulsion system of any preceding clause, wherein the fan includes a tip, wherein the tip of the fan is positioned a first distance from an axis of rotation of the fan, wherein the second chord length is positioned a second distance from the axis of rotation of the fan, and wherein the second distance is at least 70% of the first distance.

The unducted propulsion system of any preceding clause, wherein the ratio is less than or equal to 0.6, wherein the fan includes a tip, wherein the tip of the fan is positioned a first distance from an axis of rotation of the fan, wherein the second chord length is positioned a second distance from the axis of rotation of the fan, and wherein the second distance is at least 80% of the first distance.

The unducted propulsion system of any preceding clause, wherein the ratio is less than or equal to 0.4, wherein the fan includes a tip, wherein the tip of the fan is positioned a first distance from an axis of rotation of the fan, wherein the second chord length is positioned a second distance from the axis of rotation of the fan, and wherein the second distance is at least 90% of the first distance.

The unducted propulsion system of any preceding clause, wherein the ratio is less than or equal to 0.3, wherein the fan includes a tip, wherein the tip of the fan is positioned a first distance from an axis of rotation of the fan, wherein the second chord length is positioned a second distance from the axis of rotation of the fan, and wherein the second distance is at least 90% of the first distance.

An outlet guide vane for an unducted propulsion system, the outlet guide vane comprising a leading edge, a trailing edge, a hub to couple to a nacelle of the unducted propulsion system, and a tip including a first chord length from the leading edge to the trailing edge, wherein a portion of the outlet guide vane between the hub and the tip in a radial direction defined by the unducted propulsion system includes a second chord length, and wherein a ratio of the first chord length to the second chord length is less than 0.8.

The outlet guide vane of any preceding clause, further including a belly between the hub and the tip, wherein a leading edge of the outlet guide vane at the belly defines a forwardmost portion of the outlet guide vane.

The outlet guide vane of any preceding clause, wherein the outlet guide vane is actuated to a first position for a first flight operation, and wherein the outlet guide vane is actuated to a second position for a second flight operation, wherein the second position is different than the first position, and wherein the second flight operation is different than the first flight operation.

An unducted propulsion system comprising a fan, and an outlet guide vane downstream of the fan, the outlet guide vane including a hub portion, a tip portion, and a peak positioned between the hub portion and the tip portion in a radial direction defined by the unducted propulsion system, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8.

The unducted propulsion system of any preceding clause, wherein the second chord length is a maximum chord length of the outlet guide vane, and wherein the hub portion includes the maximum chord length.

The unducted propulsion system of any preceding clause, wherein the ratio is less than or equal to 0.6.

The unducted propulsion system of any preceding clause, wherein the ratio is less than or equal to 0.4.

The unducted propulsion system of any preceding clause, wherein the ratio is less than or equal to 0.25.

The unducted propulsion system of any preceding clause, wherein the outlet guide vane includes a leading edge and a trailing portion, wherein the leading edge is formed of a metal, wherein the trailing portion is formed of a composite material, and wherein an outer radial surface of the tip portion of the outlet guide vane includes a metal tip cap.

The unducted propulsion system of any preceding clause, wherein the outlet guide vane includes a tip, wherein the ratio is a chord variation ratio, wherein a sweep from the peak to the tip is characterized by a leading edge sweep characteristic ratio of (i) a first distance from the peak to a leading edge of the tip in an axial direction defined by the unducted propulsion system to (ii) a second distance from the peak to the tip in the radial direction, wherein the leading edge sweep characteristic ratio is greater than or equal to 0.1 and less than or equal to 1.8.

The unducted propulsion system of any preceding clause, wherein the leading edge sweep characteristic ratio is greater than or equal to 0.5.

The unducted propulsion system of any preceding clause, wherein the leading edge sweep characteristic ratio is greater than or equal to 0.9.

The unducted propulsion system of any preceding clause, wherein the leading edge sweep characteristic ratio is greater than or equal to 1.4.

The unducted propulsion system of any preceding clause, wherein the leading edge sweep characteristic ratio is greater than or equal to 1.7.

An unducted propulsion system comprising a fan, and an outlet guide vane downstream of the fan, the outlet guide vane including a leading edge, a trailing edge, a hub to couple to a nacelle of the unducted propulsion system, and a tip including a first chord length from the leading edge to the trailing edge, wherein a portion of the outlet guide vane between the hub and the tip in a radial direction defined by the unducted propulsion system includes a second chord length, and wherein a ratio of the first chord length to the second chord length is less than 0.8.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein the second distance is equivalent to or between 50% and 60% of the first distance.

The unducted propulsion system of any preceding clause, wherein the tip is a first tip, wherein the fan includes a second tip, wherein the tip of the fan is positioned a first distance from an axis of rotation of the fan, wherein the outlet guide vane includes a peak positioned a second distance from the axis of rotation, and wherein the second distance is less than or equal to 70% of the first distance.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.8.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.75.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.72.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.68.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.65.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.6.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.55.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.5.

The unducted propulsion system of any preceding clause, wherein the tip is a first tip, wherein the fan includes a second tip, wherein the second tip of the fan is positioned a first distance from an axis of rotation of the fan, wherein the outlet guide vane includes a peak positioned a second distance from the axis of rotation, and wherein a ratio of the second distance to the first distance is less than or equal to 0.4.

The unducted propulsion system of any preceding clause, wherein the outlet guide vane includes a first peak, wherein the first peak is positioned at a first radius, wherein the fan includes a second peak positioned at a second radius during cruise operations, wherein the second radius is greater than the first radius.

The unducted propulsion system of any preceding clause, wherein the tip is a first tip, wherein the fan includes a second tip, wherein the tip of the fan is positioned at a first radius, wherein the outlet guide vane includes a peak positioned at a second radius, and wherein the second radius is in a range of 50% to 65% of the first radius.

The unducted propulsion system of any preceding clause, wherein the tip is a first tip, wherein the fan includes a second tip, wherein the tip of the fan is positioned at a first radius, wherein the outlet guide vane includes a peak positioned at a second radius, and wherein the second radius is in a range of 50% to 70% of the first radius.

The unducted propulsion system of any preceding clause, wherein the tip is a first tip, wherein the fan includes a second tip, wherein the second tip of the fan is positioned at a first radius, wherein the second chord length is positioned at a second radius, and wherein the second radius is at least 70% of the first radius.

The unducted propulsion system of any preceding clause, wherein the ratio is less than or equal to 0.6, wherein the tip is a first tip, wherein the fan includes a second tip, wherein the second tip is positioned at a first radius, wherein the second chord length is positioned at a second radius, and wherein the second radius is at least 80% of the first radius.

The unducted propulsion system of any preceding clause, wherein the ratio is less than or equal to 0.3, wherein the tip is a first tip, wherein the fan includes a second tip, wherein the second tip is positioned at a first radius, wherein the second chord length is positioned at a second radius, and wherein the second radius is at least 90% of the first radius.

The unducted propulsion system of any preceding clause, wherein the second distance is greater than or equal to 40% of the first distance.

The unducted propulsion system of any preceding clause, wherein the outlet guide vane includes a first peak, wherein the first peak is positioned at a first radius, wherein the fan includes a second peak positioned at a second radius, wherein the second radius is greater than the first radius.

An outlet guide vane for an unducted propulsion system, the outlet guide vane comprising a hub a tip, and a leading edge extending from the hub to the tip, wherein the leading edge includes a peak positioned between the hub and the tip in a radial direction defined by the unducted propulsion system, wherein the leading edge includes a leading edge aft sweep from the peak to the tip, wherein the leading edge aft sweep is characterized by a leading edge sweep characteristic ratio of (i) a first distance from the peak to the leading edge at the tip in an axial direction defined by the unducted propulsion system to (ii) a second distance from the peak to the tip in the radial direction, wherein the leading edge sweep characteristic ratio is greater than or equal to 0.4 and less than or equal to 1.8.

The outlet guide vane of any preceding clause, further including a trailing edge extending from the hub to the tip, wherein the trailing edge includes a valley between the hub and the tip in the radial direction, wherein the trailing edge includes a trailing edge aft sweep from the valley to the tip, wherein the trailing edge aft sweep is characterized by a trailing edge sweep characteristic ratio of (i) a third distance from the valley to the trailing edge at the tip in the axial direction to (ii) a fourth distance from the valley to the tip in the radial direction, wherein the trailing edge sweep characteristic ratio is greater than or equal to 0.2 and less than or equal to 1.8.

The outlet guide vane of any preceding clause, further including a trailing edge extending from the hub to the tip, wherein the trailing edge includes a valley between the hub and the tip in the radial direction, wherein the trailing edge includes a trailing edge aft sweep from the valley to the tip, wherein the trailing edge aft sweep is characterized by a trailing edge sweep characteristic ratio of (i) a third distance from the valley to the trailing edge at the tip in the axial direction to (ii) a fourth distance from the valley to the tip in the radial direction, wherein the trailing edge sweep characteristic ratio is greater than or equal to 0.3 and less than or equal to 1.8.

The unducted propulsion system of any preceding clause, wherein the outlet guide vane includes a wavy leading edge.

The unducted propulsion system of any preceding clause, wherein the wavy leading edge includes a convex portion contiguous with at least one of a hub or a tip of the outlet guide vane.

The unducted propulsion system of any preceding clause, wherein the wavy leading edge includes a concave portion contiguous with at least one of a hub or a tip of the outlet guide vane.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An aircraft comprising:
a fuselage;
a pair of wings extending from the fuselage,
two or more unducted fan propulsors, each of the unducted fan propulsors mounted relative to one of the wings on a high pressure side thereof, the respective unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the respective unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8;
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
an airfoil section having an effective quarter chord point QC; and
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

2. The aircraft of claim 1, wherein 0.15≤RL/D.

3. The aircraft of claim 1, wherein 0.35≤RL/D, and preferably RL/D is about 0.72.

4. The aircraft of claim 1, wherein θ is between 198° and 310°, and preferably between 205° and 285°.

5. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

6. The aircraft of claim 1, wherein the unducted fan propulsor has a dimensionless cruise fan net thrust parameter expressed as follows:
$$0.15 > \frac{{F}_{net}}{{ρ}_{0} {A}_{a n} {V}_{0}^{2}} > 0.06 ,$$
wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

7. The aircraft of claim 1, wherein the unducted fan propulsor is undermounted to the airfoil with one or more intermediate structures.

8. The aircraft of claim 1, wherein the P of the unducted fan propulsor is variable to accommodate different operating conditions.

9. The aircraft of claim 1, wherein the second chord length is a maximum chord length of the outlet guide vane, and wherein the hub portion includes the maximum chord length or the peak is defined at a same radius as the maximum chord length.

10. The aircraft of claim 1, wherein the ratio of the first chord length to the second chord length is less than or equal to 0.6.

11. The aircraft of claim 1, wherein the outlet guide vane further includes a leading edge and a trailing portion, wherein the leading edge is formed of a metal, wherein the trailing portion is formed of a composite material, and wherein an outer radial surface of the tip portion of the outlet guide vane includes a metal tip cap.

12. The aircraft of claim 1, wherein the tip portion of the outlet guide vane further includes a tip, wherein the ratio is a chord variation ratio, wherein a sweep from the peak to the tip is characterized by a leading edge sweep characteristic ratio of (i) a first distance from the peak to a leading edge of the tip in an axial direction defined by the respective unducted fan propulsor to (ii) a second distance from the peak to the tip in the radial direction, wherein the leading edge sweep characteristic ratio is greater than or equal to 0.1 and less than or equal to 1.8.

13. The aircraft of claim 12, wherein the leading edge sweep characteristic ratio is greater than or equal to 0.5 and less than or equal to 1.8.

14. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8;
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

15. The aircraft of claim 14, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

16. The aircraft of claim 14, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

17. The aircraft of claim 14, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

18. The aircraft of claim 14, wherein the second chord length is a maximum chord length of the outlet guide vane, and wherein the hub portion includes the maximum chord length or the peak is defined at a same radius as the maximum chord length.

19. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D), and wherein another of the forward and rearward array of blades are nonrotating blades including an outlet guide vane, the outlet guide vane including a hub portion, a tip portion, and a peak positioned between the hub portion and the tip portion in a radial direction defined by the unducted fan propulsor, the hub portion including a forward sweep, the tip portion including an aft sweep, wherein the outlet guide vane includes a first chord length in the tip portion, wherein the outlet guide vane includes a second chord length, and wherein a ratio of the first chord length to the second chord length is less than 0.8;
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{R L}{D} \frac{( \begin{matrix}\sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} > 0$$
$$and$$
$$\frac{R L}{D} \frac{( \begin{matrix}\sqrt{\begin{matrix}( 1.4161 * [ 1.88978 * {sin}^{2} ( θ ) - 0.0875 * {cos}^{2} ( θ ) + \\ 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} < 0$$

20. The aircraft of claim 19, wherein the second chord length is a maximum chord length of the outlet guide vane, and wherein the hub portion includes the maximum chord length or the peak is defined at a same radius as the maximum chord length.
